(19) United States
(12) Patent Application Publication
(10) Pub. No.: US 2024/0326789 A1
(43) Pub. Date: Oct. 3, 2024

(54) DRIVING ASSISTANCE APPARATUS, VEHICLE, NON-TRANSITORY RECORDING MEDIUM CONTAINING COMPUTER PROGRAM, AND DRIVING ASSISTANCE METHOD

(71) Applicant: SUBARU CORPORATION, Tokyo (JP)

(72) Inventor: Ikuo GOTO, Tokyo (JP)

(21) Appl. No.: 18/737,245

(22) Filed: Jun. 7, 2024

Related U.S. Application Data
(63) Continuation of application No. PCT/JP2022/044340, filed on Dec. 1, 2022.

(51) Int. Cl. B60W 30/09; B60W 30/16

(52) U.S. Cl. CPC B60W 30/09; B60W 30/162; B60W 2554/4041; B60W 2554/804

(57) ABSTRACT

A driving assistance apparatus configured to assist driving of a vehicle includes one or more processors and one or more memories. The one or more processors execute a speed change plan setting process of setting one or more speed change plans based on a current position of the vehicle, etc. The speed change plan defines a speed change of the vehicle from the current position to a particular point, and is configured to allow the vehicle to pass the particular point at a speed lower than an upper-limit speed. The one or more processors execute a visualization control process of visualizing a virtual object when the speed of the vehicle is higher than a speed defined by the one or more speed change plans. The visualization control process is configured to allow a driver to recognize a risk of contact between the vehicle and the virtual object.

### CROSS REFERENCE TO RELATED APPLICATIONS

This application is continuation of International Application No. PCT/JP2022/044340, filed on Dec. 1, 2022, the entire contents of which are hereby incorporated by reference.

### BACKGROUND

The disclosure relates to a driving assistance apparatus, a vehicle, a non-transitory recording medium containing a computer program, and a driving assistance method.

In order to prevent or reduce accidents and to reduce a driving load, research and development have been recently conducted on an automated driving technique and a driving assistance technique. The automated driving technique allows for automated driving of a vehicle such as an automobile. The driving assistance technique assists driving of a vehicle in terms of safety while a driver is driving the vehicle. The driving assistance technique may involve, for example, emergency braking.

In such an automated driving technique or driving assistance technique, it is desirable to achieve a driving result that reassures a driver. Therefore, various methods have been recently proposed, including, for example, a method of selecting an optimum route, taking into consideration of an obstacle around a vehicle.

For example, a recently proposed driving assistance technique performs automated driving or assists driving performed by a driver to prevent a vehicle from being involved in an accident with an object such as another vehicle coming from another direction, for example, at a poor-view intersection where a blind spot can be created by an obstacle.

One of such driving assistance techniques is a system that presents a risk of contact between a vehicle and a mobile body that is possibly to come out from a blind spot region of a driver who drives the vehicle, and thereby allows the driver to safely drive the vehicle.

A known example of such a system provides a profile that specifies not only a recommended speed of a vehicle but also a speed change to a timing when a speed of the vehicle reaches the recommended speed, to thereby prevent the vehicle from coming into contact with an assumed mobile body. For example, reference is made to Japanese Patent (JP-B) No. 5776838.

As the technique of guiding the driver to drive at a speed that prevents the vehicle from coming into contact with the mobile body that is possibly to come out from a blind spot region of the driver as described above, for example, known is a technique of, when a driving assistance system recognizes, by means of, for example, vehicle-to-vehicle communication, an object that is unviewable from the driver, displaying an outline of the object and superimposing the outline of the object on an image such as a navigation image. For example, reference is made to Japanese Unexamined Patent Application Publication (JP-A) No. 2002-117494.

### SUMMARY

An aspect of the disclosure provides a driving assistance apparatus configured to assist driving of a vehicle. The driving assistance apparatus includes one or more processors and one or more memories. The one or more memories are communicably coupled to the one or more processors. The one or more processors are configured to set a position and a movement speed of a virtual object that is possibly to come out from a blind spot region present in a traveling direction of the vehicle. The one or more processors are configured to execute a particular point identification process of identifying, as a particular point, a point at which the traveling direction of the vehicle and a moving direction of the virtual object intersect. The one or more processors are configured to execute an upper-limit speed setting process of setting, as an upper-limit speed, a speed that a speed of the vehicle reaches by deceleration and that is of an upper limit to allow for avoidance of contact between the vehicle and the virtual object at the particular point. The one or more processors are configured to execute a speed change plan setting process of setting one or more speed change plans based on a current position of the vehicle, a distance from the current position of the vehicle to the particular point, a current speed of the vehicle, and the upper-limit speed. The one or more speed change plans each define a speed change of the vehicle from the current position of the vehicle to the particular point. The one or more speed change plans are each configured to allowing the vehicle to pass the particular point at a speed lower than the upper-limit speed. The one or more processors are configured to execute a visualization control process of visualizing the virtual object when the speed of the vehicle is determined as being higher than a speed defined by the one or more speed change plans. The visualization control process is configured to allowing a driver who drives the vehicle to recognize a risk of the contact between the vehicle and the virtual object.

An aspect of the disclosure provides a vehicle that includes a driving assistance apparatus. The driving assistance apparatus is configured to assist driving of the vehicle. The driving assistance apparatus is configured to set a position and a movement speed of a virtual object that is possibly to come out from a blind spot region present in a traveling direction of the vehicle. The driving assistance apparatus is configured to execute a particular point identification process of identifying, as a particular point, a point at which the traveling direction of the vehicle and a moving direction of the virtual object intersect. The driving assistance apparatus is configured to execute an upper-limit speed setting process of setting, as an upper-limit speed, a speed that a speed of the vehicle reaches by deceleration and that is of an upper limit to allow for avoidance of contact between the vehicle and the virtual object at the particular point. The driving assistance apparatus is configured to execute a speed change plan setting process of setting one or more speed change plans based on a current position of the vehicle, a distance from the current position of the vehicle to the particular point, a current speed of the vehicle, and the upper-limit speed. The one or more speed change plans each define a speed change of the vehicle from the current position of the vehicle to the particular point. The one or more speed change plans are each configured to allow the vehicle to pass the particular point at a speed lower than the upper-limit speed. The driving assistance apparatus is configured to execute a visualization control process of visualizing the virtual object when the speed of the vehicle is determined as being higher than a speed defined by the one or more speed change plans. The visualization control process is configured to allow a driver who drives the vehicle to recognize a risk of the contact between the vehicle and the virtual object.

An aspect of the disclosure provides a non-transitory computer readable recording medium containing a computer program to be applied to a driving assistance apparatus. The driving assistance apparatus is configured to assist driving of a vehicle. The computer program causes, when executed by a computer, the computer to implement a method. The method includes: setting a position and a movement speed of a virtual object that is possibly to come out from a blind spot region present in a traveling direction of the vehicle; executing a particular point identification process of identifying, as a particular point, a point at which the traveling direction of the vehicle and a moving direction of the virtual object intersect; executing an upper-limit speed setting process of setting, as an upper-limit speed, a speed that a speed of the vehicle reaches by deceleration and that is of an upper limit to allow for avoidance of contact between the vehicle and the virtual object at the particular point; executing a speed change plan setting process of setting one or more speed change plans based on a current position of the vehicle, a distance from the current position of the vehicle to the particular point, a current speed of the vehicle, and the upper-limit speed, the one or more speed change plans each defining a speed change of the vehicle from the current position of the vehicle to the particular point, the one or more speed change plans each being configured to allowing the vehicle to pass the particular point at a speed lower than the upper-limit speed; and executing a visualization control process of visualizing the virtual object when the speed of the vehicle is determined as being higher than a speed defined by the one or more speed change plans, the visualization control process being configured to allow a driver of the vehicle to recognize a risk of the contact between the vehicle and the virtual object.

An aspect of the disclosure provides a driving assistance method of assisting driving of a vehicle by a driving assistance system configured to assist the driving of the vehicle. The driving assistance method includes causing the driving assistance system to: set a position and a movement speed of a virtual object that is possibly to come out from a blind spot region present in a traveling direction of the vehicle; execute a particular point identification process of identifying, as a particular point, a point at which the traveling direction of the vehicle and a moving direction of the virtual object intersect; execute an upper-limit speed setting process of setting, as an upper-limit speed, a speed that a speed of the vehicle reaches by deceleration and that is of an upper limit to allow for avoidance of contact between the vehicle and the virtual object at the particular point; execute a speed change plan setting process of setting one or more speed change plans based on a current position of the vehicle, a distance from the current position of the vehicle to the particular point, a current speed of the vehicle, and the upper-limit speed, the one or more speed change plans each defining a speed change of the vehicle from the current position of the vehicle to the particular point, the one or more speed change plans each being configured to allow the vehicle to pass the particular point at a speed lower than the upper-limit speed; and execute a visualization control process of visualizing the virtual object when the speed of the vehicle is determined as being higher than a speed defined by the one or more speed change plans, the visualization control process being configured to allow a driver who drives the vehicle to recognize a risk of the contact between the vehicle and the virtual object.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a system configuration diagram illustrating a configuration example of a vehicle control system mounted in a vehicle according to one example embodiment of the disclosure.

FIG. 2 is a schematic diagram illustrating a configuration example of the vehicle in which the vehicle control system of one example embodiment is mounted.

FIG. 3 is a diagram for describing a driving assistance control process based on a risk of contact between the vehicle and a coming-out object, to be executed by the vehicle control system of one example embodiment.

FIG. 4 is a diagram for describing a coming-out object setting process including a particular point identification process, to be executed by the vehicle control system of one example embodiment.

FIG. 5 is a diagram for describing an upper-limit speed setting process to be executed by the vehicle control system of one example embodiment.

FIG. 6 is a diagram for describing a visualization control process to be executed by the vehicle control system of one example embodiment.

FIG. 7 is a diagram for describing the visualization control process to be executed by the vehicle control system of one example embodiment.

FIG. 8 is a diagram for describing the visualization control process to be executed by the vehicle control system of one example embodiment.

FIG. 9 is a diagram for describing the visualization control process to be executed by the vehicle control system of one example embodiment.

FIG. 10 is a flowchart illustrating an operation of the driving assistance control process based on the risk of the contact between the vehicle and the coming-out object, to be executed by a driving assistance control apparatus of one example embodiment.

FIG. 11 is a flowchart illustrating the operation of the driving assistance control process based on the risk of the contact between the vehicle and the coming-out object, to be executed by the driving assistance control apparatus of one example embodiment.

FIG. 12 is a diagram for describing intermittent display of the coming-out object according to Modification 1.

### DETAILED DESCRIPTION

A system disclosed in JP-B No. 5776838 simply presents a recommended speed. When a driver drives a vehicle in a manner deviating from a profile, it is difficult for the system to perform appropriate driving assistance and also to reduce a risk of contact between the vehicle and a mobile body.

With a system disclosed in JP-A No. 2002-117494, when a method such as vehicle-to-vehicle communication is unavailable and, for example, an object present in a blind spot region is therefore unrecognizable on the system, it is difficult to display and superimpose the unrecognizable object. With the system disclosed in JP-A No. 2002-117494, it is also difficult to reduce or avoid a risk of contact between the vehicle and the unrecognizable object.

It is desirable to provide a driving assistance apparatus, a vehicle, a non-transitory recording medium, and a driving assistance method that each make it possible to allow a driver who drives a vehicle to recognize a risk of contact between the vehicle and a virtual object that is possibly to come out from a blind spot region.

It is desirable to provide a driving assistance apparatus, a vehicle, a non-transitory recording medium, and a driving assistance method that each make it possible to guide a speed of a vehicle to a safer speed by allowing a driver who drives the vehicle to recognize a risk of contact between the vehicle and a virtual object, and to thereby reduce the risk of the contact around a blind spot region.

### A: Features of Example Embodiment of Disclosure

(1) A driving assistance apparatus according to an example embodiment of the disclosure is configured to assist driving of a vehicle.

The driving assistance apparatus includes:

one or more processors; and

one or more memories communicably coupled to the one or more processors, in which the one or more processors are configured to:
set a position and a movement speed of a virtual object that is possibly to come out from a blind spot region present in a traveling direction of the vehicle;
execute a particular point identification process of identifying, as a particular point, a point at which the traveling direction of the vehicle and a moving direction of the virtual object intersect;
execute an upper-limit speed setting process of setting, as an upper-limit speed, a speed that a speed of the vehicle reaches by deceleration and that is of an upper limit to allow for avoidance of contact between the vehicle and the virtual object at the particular point;
execute a speed change plan setting process of setting one or more speed change plans based on a current position of the vehicle, a distance from the current position of the vehicle to the particular point, a current speed of the vehicle, and the upper-limit speed, the one or more speed change plans each defining a speed change of the vehicle from the current position of the vehicle to the particular point, the one or more speed change plans each being configured to allow the vehicle to pass the particular point at a speed lower than the upper-limit speed; and
execute a visualization control process of visualizing the virtual object when the speed of the vehicle is determined as being higher than a speed defined by the one or more speed change plans, the visualization control process being configured to allow a driver who drives the vehicle to recognize a risk of the contact between the vehicle and the virtual object.

Note that an embodiment of the disclosure may also be implementable by a driving assistance control apparatus mounted in a vehicle and configured to execute each of the above-described processes, a non-transitory recording medium containing a computer program configured to execute each of the above-described processes, or a driving assistance method of executing each of the above-described processes.

With this configuration, the driving assistance apparatus, the vehicle, the non-transitory recording medium, and the driving assistance method according to embodiments of the disclosure each make it possible to, when the speed of the vehicle deviates from the set speed change plan, present, to the driver, the risk of the contact between the vehicle and the virtual object at the particular point as visualized information, in accordance with the speed change of the vehicle.

That is, the driving assistance apparatus, the vehicle, the non-transitory recording medium, and the driving assistance method according to the embodiments of the disclosure each make it possible to, when the speed of the vehicle deviates from the set speed change plan, feedback, to the driver, a possibility of the risk of the contact between the vehicle and the virtual object based on the speed change of the vehicle, as the visualized information.

Accordingly, the driving assistance apparatus, the vehicle, the non-transitory recording medium, and the driving assistance method according to the embodiments of the disclosure each make it possible to allow the driver to recognize the risk of the contact between the vehicle and an object that is possibly to come out from the blind spot region, and to reliably guide the speed of the vehicle to a speed that allows for avoidance of the contact between the vehicle and the virtual object. It is therefore possible to reduce a risk of contact around the blind spot region.

Note that the “virtual object” may encompass, for example, another vehicle such as an automobile or a bicycle; a pedestrian; and any other object.

The “position and the movement speed of the virtual object” may be assumed in advance. For example, the position and the movement speed of the virtual object may be assumed based on a position and a speed of the vehicle.

The “speed change plan defining the speed change of the vehicle from the current position of the vehicle to the particular point” may refer to a path of the speed change of the vehicle determined based on a distance from the position of the vehicle to the particular point.

“When the speed of the vehicle is determined as being higher than the speed defined by the one or more speed change plans” may refer to a case where the speed of the vehicle is determined as being higher than the same or completely the same speed as the speed defined by the one or more speed change plans or a speed regarded as being substantially the same as the speed defined by the one or more speed change plans.

The “speed regarded as being substantially the same” may refer to, for example, a speed within a predetermined range with respect to the same speed as the speed defined by the one or more speed change plans, or an average speed in a certain period.

The “visualizing the virtual object” may refer to presenting, in various methods, the visualized information related to the virtual object that allows the driver to virtually recognize the virtual object.

For example, the various methods may include creating an image of the virtual object in a real space, on map data, on an image of the real space, or on an image resembling the real space, in association therewith.

For example, when “the image of the virtual image is created in the real space in association therewith”, the various methods may include displaying the virtual object on a transparent object when the driver looks in the traveling direction through the transparent object. Non-limiting examples of the transparent object may include a windshield glass and eyeglasses.

For example, when “the image of the virtual image is created on the map data in association therewith”, the various methods may include displaying and superimposing the visualized information related to the virtual object on a display region, on the map data, in which the blind spot region is created.

For example, when “the image of the virtual image is created in association with an image generated by performing imaging of the real space”, the various methods may include superimposing the image of the virtual object in association with a blind spot portion of an image of a surrounding region. The image of the surrounding region may be acquired by a front camera mounted in the vehicle.

For example, when “the image of the virtual image is created on an image resembling the real space in association therewith”, the various methods may include creating the image of the virtual object and superimposing the created image on an image simplifying the real space. The image simplifying the real space may be displayed on a center information display device or on a meter display device of a steering column.
(2) In addition, for example, the driving assistance apparatus according to the example embodiment of the disclosure may have the following configuration.

The one or more processors may be configured to, as the visualization control process, change a method of visualizing the virtual object among a case where the speed of the vehicle is determined as being higher than the speed defined by the one or more speed change plans, a case where the speed of the vehicle is determined as matching the speed defined by the one or more speed change plans, and a case where the speed of the vehicle is determined as being lower than the speed defined by the one or more speed change plans.

With this configuration, for example, the driving assistance apparatus according to the example embodiment of the disclosure makes it possible to change the visualizing method based on a possibility of the contact between the vehicle and the virtual object at the particular point. It is therefore possible to allow the driver to accurately recognize the risk of the contact.

Note that the “case where the speed of the vehicle is determined as matching the speed defined by the one or more speed change plans” may refer to a case where the speed of the vehicle is the same as the speed defined by the one or more speed change plans or the speed regarded as substantially the same as the speed defined by the one or more speed change plans.

The “case where the speed of the vehicle is determined as being lower than the speed defined by the one or more speed change plans” may refer to a case where the speed of the vehicle is lower than the speed defined by the one or more speed change plans or the speed regarded as substantially the same as the speed defined by the one or more speed change plans.
(3) In addition, for example, the driving assistance apparatus according to the example embodiment of the disclosure may have the following configuration.

The one or more processors may be configured to stop the visualization control process when the speed of the vehicle is lower than the speed defined by the one or more speed change plans.

With this configuration, for example, the driving assistance apparatus according to the example embodiment of the disclosure makes it possible to determine that the risk of the contact between the vehicle and the virtual object is reduced or eliminated when the speed of the vehicle becomes lower than the speed defined by the one or more speed change plans, and to stop presenting information that may be unnecessary.

Accordingly, for example, the driving assistance apparatus according to the example embodiment of the disclosure makes it possible to limit the information to be looked at by the driver. It is therefore possible to provide an environment that more reliably allows for safe driving.
(4) In addition, for example, the driving assistance apparatus according to the example embodiment of the disclosure may have the following configuration.

The one or more processors may be configured to, as the visualization control process, intermittently visualize the virtual object in association with a real space or intermittently visualize the virtual object on map data.

With this configuration, for example, the driving assistance apparatus according to the example embodiment of the disclosure makes it possible to allow the driver to recognize the visualized virtual object in such a manner that the virtual object is present at a position corresponding to a timing when the vehicle and the virtual object are to come into contact at an estimated contact point, at each timing of the intermittent display. Accordingly, for example, the driving assistance apparatus according to the example embodiment of the disclosure makes it possible to more reliably allow the driver to recognize the virtual object present in the blind spot region of the driver.

### B: Details of Example Embodiment of Disclosure

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale.

Throughout the present specification and the drawings, elements having substantially the same function and configuration are denoted with the same reference numerals to avoid any redundant description. In addition, elements that are not directly related to any embodiment of the disclosure are unillustrated in the drawings.

### B1: Vehicle Control System

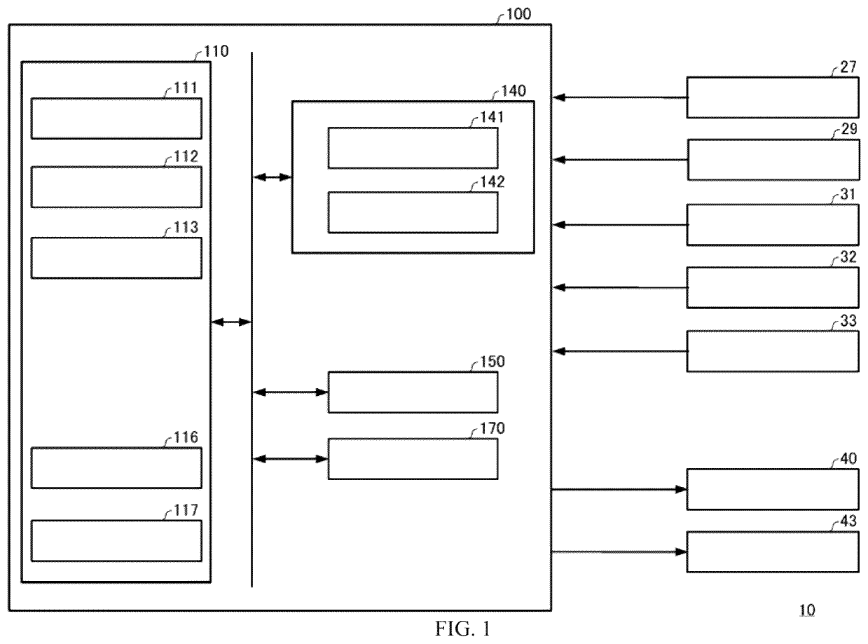

Referring to FIG. 1, a description is provided first of an outline of a vehicle control system 10 that is to be mounted in an own vehicle M and serves as a driving assistance system including a driving assistance control apparatus 100. In one embodiment, the own vehicle M may serve as a “vehicle”. In one embodiment, the driving assistance control apparatus 100 may serve as a “driving assistance apparatus”.

FIG. 1 is a system configuration diagram illustrating a configuration example of the vehicle control system 10 according to an example embodiment that is to be mounted in the own vehicle M and includes the driving assistance control apparatus 100.

### [Outline of Vehicle Control System]

The vehicle control system 10 may be an apparatus to be mounted in the own vehicle M and may be a system that performs driving assistance adapted to causing the own vehicle M to travel automatedly in an automated driving mode or to assisting driving of a driver while the driver is driving the own vehicle M in a manual driving mode.

For example, the vehicle control system 10 of the example embodiment may be configured to execute a process related to guidance display, during driving assistance in a control adapted to assisting the driver who is driving the own vehicle M, i.e., a manual driving assistance control. The guidance display may be adapted to guiding a speed of the own vehicle M to a particular speed.

For example, as illustrated in FIG. 1, the vehicle control system 10 may include a vehicle operation/behavior sensor 27, a global navigation satellite system (GNSS) antenna 29, a vehicle outside imaging camera 31, and a surrounding environment sensor 32.

The vehicle control system 10 may also include a map data storage 33, a human machine interface (HMI) 43, a vehicle drive controller 40, and the driving assistance control apparatus 100. The driving assistance control apparatus 100 may execute a control adapted to assisting driving of the own vehicle M performed by the driver.

The vehicle operation/behavior sensor 27 and the GNSS antenna 29 may each be directly coupled to the driving assistance control apparatus 100.

The vehicle outside imaging camera 31, the surrounding environment sensor 32, the map data storage 33, the HMI 43, and the vehicle drive controller 40 may each also directly coupled to the driving assistance control apparatus 100.

In some example embodiments, the vehicle operation/behavior sensor 27, the GNSS antenna 29, the vehicle outside imaging camera 31, the surrounding environment sensor 32, the map data storage 33, the HMI 43, and the vehicle drive controller 40 may each be indirectly coupled to the driving assistance control apparatus 100 via a communication system. Non-limiting examples of the communication system may include a controller area network (CAN) and a local internet (LIN).

### [Vehicle Operation/Behavior Sensor]

The vehicle operation/behavior sensor 27 may include one or more sensors configured to detect an operation state and behavior of the own vehicle M.

For example, the vehicle operation/behavior sensor 27 may include one or more of a vehicle speed sensor, an acceleration sensor, and an angular velocity sensor, and may detect information regarding the behavior of the own vehicle M. Non-limiting examples of the information regarding the behavior of the own vehicle M may include a vehicle speed, a longitudinal acceleration rate, a lateral acceleration rate, and a yaw rate.

For example, the vehicle operation/behavior sensor 27 may include one or more of an accelerator position sensor, a brake stroke sensor, a brake pressure sensor, a steering angle sensor, an engine speed sensor, a brake lamp switch, and a signal light switch.

The vehicle operation/behavior sensor 27 may detect information regarding the operation state of the own vehicle M. Non-limiting examples of the information regarding the operation state of the own vehicle M may include a steering angle of a steering wheel 13 or a steered wheel, an accelerator position, a brake operation amount, an on and off state of the brake lamp switch, and an on and off state of the signal light switch.

The vehicle operation/behavior sensor 27 may further include a driving mode switching switch, and may detect setting information related to the automated driving mode. The vehicle operation/behavior sensor 27 may transmit a sensor signal including the detected information to the driving assistance control apparatus 100.

### [GNSS Antenna]

The GNSS antenna 29 may receive a satellite signal from a satellite such as a global positioning system (GPS) satellite.

The GNSS antenna 29 may transmit, to the driving assistance control apparatus 100, position information regarding the own vehicle M on the map data included in the received satellite signal.

In some example embodiments, the vehicle control system 10 may include, instead of the GNSS antenna 29, an antenna configured to receive a satellite signal from another satellite system that identifies a position of the own vehicle M.

### [Vehicle Outside Imaging Camera]

The vehicle outside imaging camera 31 may be adapted to acquiring information regarding a surrounding region of the own vehicle M, and may include front imaging cameras 31LF and 31RF and a rear imaging camera 31R.

For example, the front imaging cameras 31LF and 31RF and the rear imaging camera 31R may each include an imaging device such as a charged-coupled device (CCD) or a complementary metal-oxide semiconductor (CMOS).

The front imaging cameras 31LF and 31RF may perform imaging of a front region of the own vehicle M to generate image data, and may supply the generated image data to the driving assistance control apparatus 100. The rear imaging camera 31R may perform imaging of a rear region of the own vehicle M to generate image data, and may supply the generated image data to the driving assistance control apparatus 100.

The front imaging cameras 31LF and 31RF may be configured as a stereo camera including a pair of left and right cameras. The rear imaging camera 31R may be configured as what is called a monocular camera. In some example embodiments, however, the front imaging cameras 31LF and 31RF and the rear imaging camera 31R may each be either a stereo camera or a monocular camera.

In some example embodiments, the vehicle outside imaging camera 31 may include, instead of or in addition to the front imaging cameras 31LF and 31RF and the rear imaging camera 31R, for example, any of a camera provided on a side mirror 11L to perform imaging of a left-rear region of the own vehicle M and a camera provided on a side mirror 11R to perform imaging of a right-rear region of the own vehicle M.

### [Surrounding Environment Sensor]

The surrounding environment sensor 32 may detect any of a person and an obstacle around the own vehicle M. For example, the surrounding environment sensor 32 may include one or more of a high-frequency radar sensor, an ultrasonic sensor, and a light detection and ranging (LiDAR).

For example, the surrounding environment sensor 32 may be configured to detect any object present around the own vehicle M, such as another vehicle, a bicycle, a building, a utility pole, a traffic sign, a traffic light, a natural object, or any other obstacle.

The surrounding environment sensor 32 may transmit a sensor signal including the detected data to the driving assistance control apparatus 100.

### [Map Data Storage]

The map data storage 33 may be a storage medium that contains the map data. The map data storage 33 may include, for example, a memory device. The map data storage 33 may include, for example, a storage device such as a magnetic disk, an optical disk, or a flash memory.

Non-limiting examples of the memory device may include a random access memory (RAM) and a read only memory (ROM). Non-limiting examples of the magnetic disk may include a hard disk drive (HDD).

Non-limiting examples of the optical disk may include a compact disc (CD) and a digital versatile disc (DVD). Non-limiting examples of the flash memory may include a solid state drive (SSD) and a universal serial bus (USB) memory.

The map data of the example embodiment may include data regarding a reference path that is a path to be used as a reference when the own vehicle M travels each road.

In some example embodiments, the map data storage 33 may be a storage medium that contains map data to be used by an unillustrated navigation system that assists driving performed by the driver and guides the own vehicle M to a destination.

### [HMI]

The HMI 43 may be driven by the driving assistance control apparatus 100 and may perform an operation of notifying the driver of various kinds of information, for example, by means of image display or audio output.

For example, the HMI 43 may include an unillustrated display device and an unillustrated speaker provided in an instrument panel.

In some example embodiments, the display device may be a display device of the navigation system. In some example embodiments, the HMI 43 may also serve as a head-up display (HUD). The HUD may display information on the windshield, superimposing an image on scenery around the own vehicle M.

### [Vehicle Drive Controller]

The vehicle drive controller 40 may include one or more control systems configured to control drive of the own vehicle M.

For example, the vehicle drive controller 40 may include any of an engine control system, a motor control system, an electric steering system, and a braking system. The engine control system and the motor control system may each control driving force of the own vehicle M. The electric steering system may control a steering angle of the steering wheel 13 or the steered wheel. The braking system may control braking force of the own vehicle M.

In some example embodiment, the vehicle drive controller 40 may include a transmission system that performs shifting of an output outputted from an engine or a drive motor and transmits the resultant to a driving wheel.

When a driving condition is set by the driving assistance control apparatus 100 in the automated driving mode or the manual driving mode, the vehicle drive controller 40 may execute a control adapted to driving assistance during automated driving or manual driving, based on the set driving condition.

For example, the vehicle drive controller 40 may control, based on the set driving condition, any of the engine control system, the motor control system, the electric steering system that controls the steering angle of the steering wheel 13 or the steered wheel, and the braking system that controls the braking force of the own vehicle M.

### [Driving Assistance Control Apparatus]

The driving assistance control apparatus 100 may receive various kinds of data including, without limitation, the image data transmitted from each of the cameras included in the vehicle outside imaging camera 31 described above and the data regarding the operation state and the behavior of the own vehicle M transmitted from the vehicle operation/behavior sensor 27.

The driving assistance control apparatus 100 may receive the information regarding the position of the own vehicle M on the map data transmitted from the GNSS antenna 29. Hereinafter, the information regarding the position of the own vehicle M on the map data may sometimes be referred to as “position information”.

Based on the received pieces of data and information, the driving assistance control apparatus 100 may execute an automated driving control or a driving assistance control. The automated driving control may be a control adapted to the automated driving of the own vehicle M. The driving assistance control may be adapted to assisting the driving of the own vehicle M performed by the driver.

For example, the driving assistance control apparatus 100 may be configured to, based on an assumption that an object is to come out from a blind spot region recognized in the traveling direction, visualize the object in association with the blind spot region or display the object on the map data in association with the blind spot region, as the driving assistance control.

### B2: Vehicle

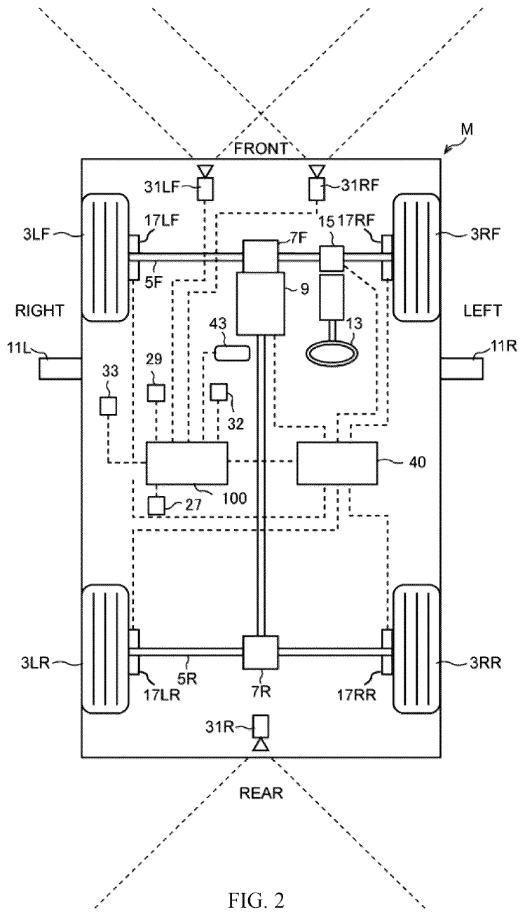

Referring to FIG. 2, a description is provided next of an outline of the own vehicle M in which the driving assistance control apparatus 100 according to the example embodiment of the disclosure is mounted.

FIG. 2 is a schematic diagram illustrating a configuration example of the own vehicle M in which the vehicle control system 10 according to the example embodiment is mounted.

As illustrated in FIG. 2, the own vehicle M may include a driving force source 9 that generates driving torque of the own vehicle M, and may be configured to transmit the driving torque outputted from the driving force source 9 to wheels 3.

The own vehicle M may also include an electric steering device 15 and brake devices 17LF, 17RF, 17LR, and 17RR, as devices to be used in a driving control of the own vehicle M, as illustrated in FIG. 2. Hereinafter, the brake devices 17LF, 17RF, 17LR, and 17RR may be collectively referred to as “brake devices 17” unless a distinction is to be made between them.

The own vehicle M may be configured as a four-wheel drive vehicle that transmits the driving torque to a left-front wheel 3LF, a right-front wheel 3RF, a left-rear wheel 3LR, and a right-rear wheel 3RR. Hereinafter, the left-front wheel 3LF, the right-front wheel 3RF, the left-rear wheel 3LR, and the right-rear wheel 3RR may be collectively referred to as “wheels 3” unless a distinction is to be made between them.

In some example embodiments, the own vehicle M may be an electric vehicle including two driving motors, e.g., a front wheel driving motor and a rear wheel driving motor, or may be an electric vehicle including driving motors corresponding to the respective wheels 3.

When the own vehicle M is an electric vehicle or a hybrid electric vehicle, a secondary battery or a generator may be mounted in the own vehicle M. The secondary battery may accumulate electric power to be supplied to the driving motor. The generator may generate electric power to be used to charge a battery. Non-limiting examples of the generator may include a motor and a fuel cell.

The driving force source 9 may output the driving torque to be transmitted to a front wheel drive shaft 5F and a rear wheel drive shaft 5R via an unillustrated transmission, a front wheel differential mechanism 7F, and a rear wheel differential mechanism 7R.

The driving force source 9 may be an internal combustion engine, may be a driving motor, or may include both the internal combustion engine and the driving motor. Non-limiting examples of the internal combustion engine may include a gasoline engine and a diesel engine.

Driving of the driving force source 9 and the transmission may be controlled by the vehicle drive controller 40. The vehicle drive controller 40 may include one or more electronic control units (ECUs).

The brake devices 17LF, 17RF, 17LR, and 17RR may apply braking force to the left-front wheel 3LF, the right-front wheel 3RF, the left-rear wheel 3LR, and the right-rear wheel 3RR, respectively. The left-front wheel 3LF, the right-front wheel 3RF, the left-rear wheel 3LR, and the right-rear wheel 3RR may be a left-front driving wheel, a right-front driving wheel, a left-rear driving wheel, and a right-rear driving wheel, respectively.

The brake devices 17 may each be configured as, for example, a hydraulic brake device. Hydraulic pressure to be supplied to each of the brake devices 17 may be controlled by the vehicle drive controller 40 to generate predetermined braking force.

In the manual driving, the vehicle drive controller 40 may control the electric steering device 15 based on the steering angle of the steering wheel 13 operated by the driver. In the automated driving control, the vehicle drive controller 40 may control the electric steering device 15 based on a set traveling path.

The front wheel drive shaft 5F may be provided with the electric steering device 15. The electric steering device 15 may include, for example, an unillustrated electric motor and an unillustrated gear mechanism. The electric steering device 15 may adjust the respective steering angles of the left-front wheel 3LF and the right-front wheel 3RF by being controlled by the vehicle drive controller 40.

The vehicle drive controller 40 may include the one or more electronic control units that control driving of the driving force source 9, the electric steering device 15, and the brake devices 17, and may be configured to control driving of the transmission on an as-needed basis. The transmission may perform shifting on the output outputted from the driving force source 9 and transmit the resultant to the wheels 3.

The vehicle drive controller 40 may be configured to acquire information transmitted from the driving assistance control apparatus 100, and may be configured to execute the automated driving control of the own vehicle M.

When the own vehicle M is an electric vehicle or a hybrid electric vehicle, the brake devices 17 may be used in conjunction with regenerative braking by the driving motor.

The own vehicle M may include the vehicle outside imaging camera 31 and the surrounding environment sensor 32. The vehicle outside imaging camera 31 may include the front imaging cameras 31LF and 31RF and the rear imaging camera 31R. The own vehicle M may also include the vehicle operation/behavior sensor 27, the GNSS antenna 29, and the HMI 43 that are adapted to acquiring information regarding the surrounding environment of the own vehicle M.

For example, the front imaging cameras 31LF and 31RF and the rear imaging camera 31R may perform imaging of the front region and the rear region of the own vehicle M, respectively, to generate image data.

For example, the front imaging cameras 31LF and 31RF may be configured as a stereo camera including a pair of left and right cameras. The rear imaging camera 31R may be configured as what is called a monocular camera. In some example embodiments, however, the front imaging cameras 31LF and 31RF and the rear imaging camera 31R may each be either a stereo camera or a monocular camera. In the example embodiment, the rear imaging camera 31R may be omittable.

### B3: Driving Assistance Control Apparatus

Referring to FIG. 1 described above, a description is provided next of an example of a configuration of the driving assistance control apparatus 100 according to the example embodiment.

The driving assistance control apparatus 100 may include one or more processors. Non-limiting examples of the processor may include a central processing unit (CPU) and a micro processing unit (MPU).

A portion or all of the driving assistance control apparatus 100 may be configured to be updatable by, for example, firmware. A portion or all of the driving assistance control apparatus 100 may include, for example, a program module to be executed in accordance with a command from a device such as a CPU.

The driving assistance control apparatus 100 may execute, by executing a computer program, an automated driving control that reduces a risk such as a risk of contact between the own vehicle M and an obstacle in or around the blind spot region. The own vehicle M may be a target for which driving assistance is to be performed.

For example, as illustrated in FIG. 1, the driving assistance control apparatus 100 may include a processing device 110, a storage 140, an information storage medium 150, and a communicator 170. In some example embodiments, a portion of the processing device 110, the storage 140, the information storage medium 150, and the communicator 170 may be omitted.

The processing device 110 may perform various processes of the example embodiment by reading an application program stored in the information storage medium 150 and executing the read application program. Hereinafter, the application program may also be referred to as an “application”.

The application stored in the information storage medium 150 may be of any kind. In some example embodiments, the processing device 110 of the example embodiment may read a program and data stored in the information storage medium 150, temporarily store the read program and data in the storage 140, and perform a process based on the stored program and data.

For example, the processing device 110 may perform various processes using a main storage 141 in the storage 140 as a work area. Operations to be performed by the processing device 110 may be implemented by hardware or an application program. Non-limiting examples of the hardware may include various processors including, without limitation, a CPU and a digital signal processor (DSP).

For example, the processing device 110 may include a communication controller 111, a surrounding environment detector 112, a vehicle data obtainer 113, a driving assistance controller 116, and a notification controller 117. In some example embodiments, a portion of the communication controller 111, the surrounding environment detector 112, the vehicle data obtainer 113, the driving assistance controller 116, and the notification controller 117 may be omitted.

The communication controller 111 may perform a process of transmitting and receiving data to and from, for example, an unillustrated management server and another vehicle. For example, the communication controller 111 may control the communicator 170 to execute network communication. Non-limiting examples of the network communication may include vehicle-to-vehicle communication, road-to-vehicle communication, and mobile body communication.

The surrounding environment detector 112 may detect information regarding the surrounding environment of the own vehicle M, based on the image data transmitted from the vehicle outside imaging camera 31 and the data transmitted from the surrounding environment sensor 32.

The surrounding environment detector 112 may identify an object present around the own vehicle M by means of an object detection technique by performing image processing on the image data transmitted from the vehicle outside imaging camera 31. Non-limiting examples of the object present around the own vehicle M may include a person, another vehicle, a bicycle, a building, a natural object, and any other obstacle.

The surrounding environment detector 112 may identify various blind spot regions that serve as blind spots of the driver. Non-limiting examples of such various blind spot regions may include a blind spot region created along an identified obstacle around the own vehicle M.

For example, the surrounding environment detector 112 may calculate a position of an object forming an obstacle to the own vehicle M, or may calculate a distance between the own vehicle M and the object and relative speeds of the own vehicle M and the object.

The surrounding environment detector 112 may store, in the storage 140, data regarding the detected obstacle around the own vehicle M and the blind spot region as time-series data.

In some example embodiments, the surrounding environment detector 112 may identify the blind spot region based on various kinds of information transmitted from a device outside the own vehicle M, for example, by means of vehicle to X (V2X) communication. In this case, for example, the surrounding environment detector 112 may identify the blind spot region based on, for example, a position, a kind, and a size of the obstacle.

In some example embodiments, the surrounding environment detector 112 may identify a current position of the own vehicle M on the map data, using the position information related to the own vehicle M acquired by the GNSS antenna 29, and may identify the blind spot region based on the above-described information regarding the obstacle around the own vehicle M. Hereinafter, the current position of the own vehicle M on the map data may be referred to as a “current position”.

The vehicle data obtainer 113 may acquire data regarding the operation state and the behavior of the own vehicle M, based on the sensor signal transmitted from the vehicle operation/behavior sensor 27.

The data regarding the operation state and the behavior of the own vehicle M may include, for example, pieces of data regarding the vehicle speed, the longitudinal acceleration rate, the lateral acceleration rate, the yaw rate, the steering angle of the steering wheel 13 or the steered wheel, the accelerator position, the brake operation amount, the on and off state of the brake lamp switch, and the on and off state of the signal light switch.

The data regarding the operation state and the behavior of the own vehicle M may also include, for example, data regarding an on and off state of the automated driving mode of the own vehicle M.

The vehicle data obtainer 113 may store, in the storage 140, the acquired data regarding the operation state and the behavior of the own vehicle M as time-series data.

The driving assistance controller 116 may execute a control process related to driving assistance adapted to causing the own vehicle M to travel automatedly and safely in the automated driving mode or adapted to assisting the driving of the own vehicle M by the driver in the manual driving mode. Hereinafter, such a control process related to the driving assistance may also be referred to as a “driving assistance control process”.

For example, the driving assistance controller 116 of the example embodiment may operate in conjunction with the notification controller 117 to execute the driving assistance control process adapted to assisting the driving of the own vehicle M performed by the driver in the manual driving mode. In the manual driving mode, the driver himself or herself may perform a driving operation.

For example, the driving assistance controller 116 may allow the driver to recognize a risk of contact between the own vehicle M and a virtual object that is to come out from the blind spot region, and may execute the driving assistance control process adapted to allowing for safe driving by the driver. Hereinafter, the virtual object that is to come out from the blind spot region may be referred to as a “coming-out object”.

In addition, the driving assistance controller 116 may execute, as the driving assistance control process, a control process of guiding driving behavior of the driver in relation to various operations. Such a control process may be adapted to reducing or eliminating the risk of the contact between the own vehicle M and the coming-out object. Non-limiting examples of the various operations may include an operation on an accelerator, an operation on the steering wheel 13, and an operation on a brake.

The notification controller 117 may perform a control adapted to notifying the driver of information to be provided to the driver to guide the above-described driving behavior, by controlling driving of the HMI 43.

For example, the notification controller 117 may execute a visualization control process of visualizing an object, which is possibly to come out from the blind spot region, in association with a real space, or displaying such an object on the map data.

The storage 140 may serve as a work area for a device such as the processing device 110. An operation of the storage 140 may be implemented by hardware such as a RAM. Non-limiting examples of the RAM may include a video random access memory (VRAM).

For example, the storage 140 of the example embodiment may include the main storage 141 and a data storage 142. The main storage 141 may be used as a work area. The data storage 142 may contain data to be used in execution of each process. In some example embodiments, a portion of the main storage 141 and the data storage 142 may be omitted.

For example, the data storage 142 may contain a computer program, table data, and risk distribution data, and may also contain data such as reference data and data to be adapted to execution of various processes.

The computer program may be adapted to cause the processor to execute various operations to be executed by the driving assistance control apparatus 100. In some example embodiments, the computer program may be recorded in a recording medium built in the driving assistance control apparatus 100 or any recording medium externally attachable to the driving assistance control apparatus 100.

The information storage medium 150 may be readable by a computer. In some example embodiments, the information storage medium 150 may contain, for example, various applications, various programs including an operating system (OS), and various kinds of data to be used in the various programs.

For example, the information storage medium 150 may include, for example, a memory device, a magnetic disk, an optical disk, or a flash memory.

The communicator 170 may perform various controls adapted to communicating with an unillustrated device outside the own vehicle M. Operations of the communicator 170 may be implemented, for example, by hardware or a computer program. Non-limiting examples of the hardware may include various processors and a communication application specific integrated circuit (ASIC).

### B4: Driving Assistance Control Process Based on Risk of Contact between Own Vehicle and Coming-Out Object in Example Embodiment

### [B4. 1: Outline]

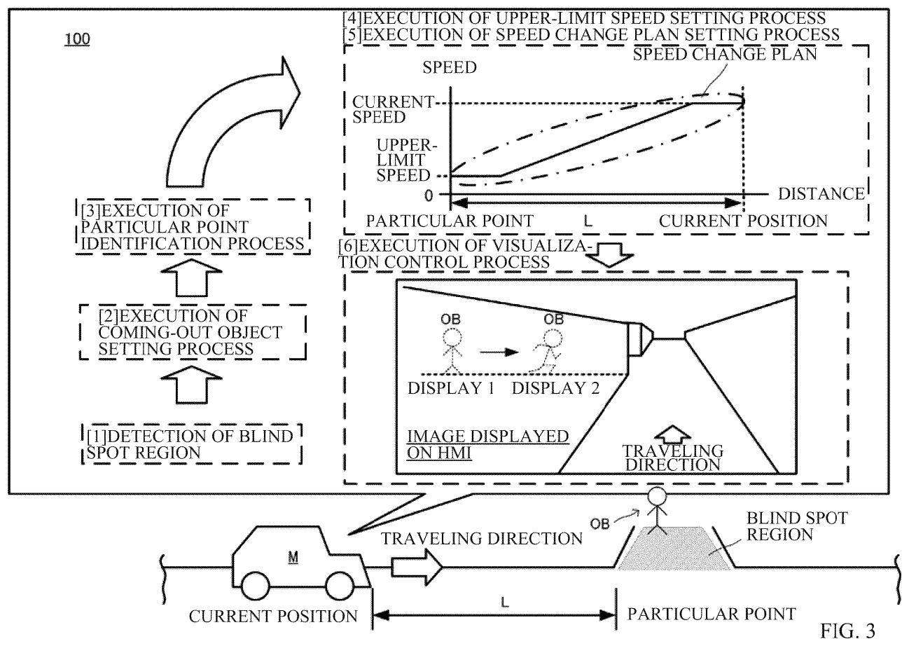

Referring to FIG. 3, a description is provided next of the driving assistance control process based on a risk of contact between the own vehicle M and the coming-out object, to be executed by the vehicle control system 10 of the example embodiment.

FIG. 3 is a diagram for describing the driving assistance control process based on the risk of the contact between the own vehicle M and the coming-out object, to be executed by the vehicle control system 10 of the example embodiment.

The driving assistance control apparatus 100 of the example embodiment may be configured to execute the driving assistance control process adapted to allowing the driver to recognize the risk of the contact between the own vehicle M and the coming-out object and thereby allowing for safe driving by the driver. The coming-out object may represent a virtual mobile body that is possibly to come out from the blind spot region. Non-limiting examples of the coming-out object may include a pedestrian.

For example, as illustrated in FIG. 3, the driving assistance control apparatus 100 may be configured to identify a particular point at which a coming-out object OB is possibly to come out from the blind spot region, and set a speed change plan. The speed change plan may define a speed change of the own vehicle M based on a distance L from the current position of the own vehicle M to the particular point.

As illustrated in FIG. 3, in order to guide the speed of the own vehicle M to the speed defined by the speed change plan, the driving assistance control apparatus 100 may be configured to present, to the driver, a position and a movement speed of the coming-out object OB estimated in association with the speed of the own vehicle M.

The driving assistance control apparatus 100 may be configured to, when the speed of the own vehicle M deviates from the set speed change plan, feed back, to the driver, a possibility of the risk of the contact between the own vehicle M and the coming-out object OB as visualized information.

For example, the driving assistance control apparatus 100 may be configured to, when the blind spot region is detected in the traveling direction of the own vehicle M, execute a coming-out object setting process of setting a position and a movement speed of the coming-out object OB that is possibly to come out from the detected blind spot region, as described in [1] and [2] in FIG. 3.

Further, the driving assistance control apparatus 100 may be configured to execute a particular point identification process of identifying, as the particular point, a point at which the traveling direction of the own vehicle M and a moving direction of the coming-out object OB intersect, as described in [3] in FIG. 3.

Further, the driving assistance control apparatus 100 may be configured to execute an upper-limit speed setting process of setting, as an upper-limit speed, a speed that the speed of the own vehicle M reaches by deceleration and that is of an upper limit to allow for avoidance of the contact between the own vehicle M and the coming-out object OB at the particular point, as described in [4] in FIG. 3.

Further, the driving assistance control apparatus 100 may be configured to execute a speed change plan setting process of setting the speed change plan, as described in [5] in FIG. 3.

In this case, the driving assistance control apparatus 100 may be configured to, as the speed change plan setting process, set one or more speed change plans based on the current position of the own vehicle M, the distance L from the current position of the own vehicle M to the particular point, a current speed of the own vehicle M, and the upper-limit speed.

Further, the driving assistance control apparatus 100 may be configured to execute the visualization control process when the speed of the own vehicle M is determined as being higher than the speed defined by the one or more speed change plans, as described in [6] in FIG. 3. The visualization control process may be adapted to allowing the driver to recognize the risk of the contact between the own vehicle M and the coming-out object OB.

In this case, the driving assistance control apparatus 100 may be configured to, as the visualization control process, visualize the coming-out object OB in association with the real space or visualize the coming-out object OB on the map data in association with the map data. The coming-out object OB is adapted to allowing the driver to recognize the risk of the contact between the own vehicle M and the coming-out object OB.

In the example embodiment, the coming-out object OB that is the virtual object may represent, for example, another vehicle or a pedestrian. Non-limiting examples of the other vehicle may include an automobile and a bicycle.

FIG. 3 illustrates an example in which, when the blind spot region is detected in the traveling direction of the own vehicle M, and when the setting of the coming-out object OB and the identification of the particular point are executed, the upper-limit speed setting process and the speed change plan setting process are executed based on the distance L from the current position of the own vehicle M to the particular point.

FIG. 3 illustrates an example of the visualization control process adapted to allowing the driver to recognize the risk of the contact between the own vehicle M and the coming-out object OB when the speed of the own vehicle M is determined as being higher than the speed defined by the speed change plan.

For example, FIG. 3 illustrates an example of the visualization process in a case where display of the coming-out object OB is changed from display 1 to display 2, to change the movement speed and the position of the coming-out object OB. The movement speed of the coming-out object OB may be expressed in shapes.

With this configuration, it is possible for the driving assistance control apparatus 100 to, when the speed of the own vehicle M deviates from the set speed change plan, present, to the driver, the risk of the contact between the own vehicle M and the coming-out object OB as the virtual object at the particular point, as the visualized information, based on the speed change of the own vehicle M.

Accordingly, it is possible for the driving assistance control apparatus 100 to guide the speed of the own vehicle M to the speed allowing for avoidance of the contact between the own vehicle M and the coming-out object OB as the virtual object, while allowing the driver to recognize the risk of the contact between the own vehicle M and the object that is possibly to come out from the blind spot region. It is therefore possible to reduce a risk of contact around the blind spot region.

### [B4. 2: Detection of Blind Spot Region]

A description is provided next of detection of the blind spot region to be executed by the vehicle control system 10 of the example embodiment.

The surrounding environment detector 112 may detect various kinds of information regarding the blind spot region, based on the data transmitted from the vehicle outside imaging camera 31 and the surrounding environment sensor 32. Hereinafter, the information regarding the blind spot region may be referred to as “blind spot region related information”.

For example, the surrounding environment detector 112 may detect the blind spot region related information such as a kind of a road corresponding to the identified position including a position of the blind spot region relative to the current position of the own vehicle M, based on the data transmitted from the vehicle outside imaging camera 31 and the surrounding environment sensor 32.

For example, the surrounding environment detector 112 may detect, as the blind spot region related information, a kind of the blind spot region, a position of the blind spot region, a size of the blind spot region, a kind of a road on which the blind spot region is created, a kind of an obstacle creating the blind spot region, and the surrounding environment of the own vehicle M. The kind of the road may include, for example, a road width or the number of traveling lanes. The surrounding environment of the own vehicle M may include, for example, a kind of a road on which the own vehicle M is traveling.

In some example embodiments, the surrounding environment detector 112 may acquire the blind spot region related information based on the current position of the own vehicle M and the map data, instead of the data transmitted from the vehicle outside imaging camera 31 and the surrounding environment sensor 32.

For example, the surrounding environment detector 112 may detect the blind spot region related information as the surrounding environment of the own vehicle M, such as the kind of the road corresponding to the identified current position of the own vehicle M, based on the identified current position of the own vehicle M and the map data.

### [B4. 3: Coming-Out Object Setting Process Including Particular Point Identification Process]

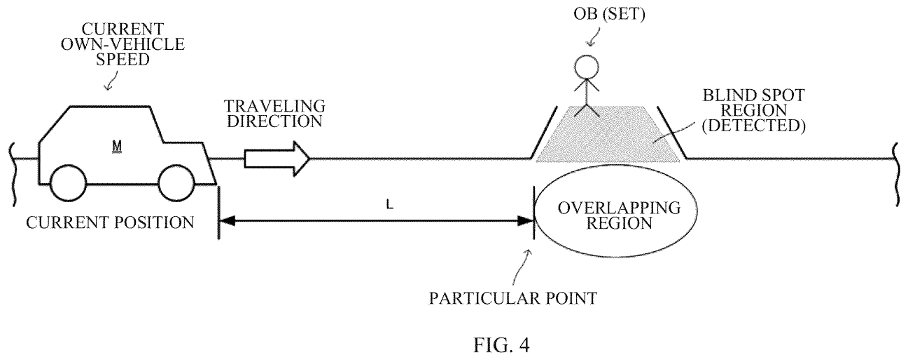

Referring to FIG. 4, a description is provided next of the coming-out object setting process including the particular point identification process, to be executed by the vehicle control system 10 of the example embodiment.

FIG. 4 is a diagram for describing the coming-out object setting process including the particular point identification process to be executed by the vehicle control system 10 of the example embodiment.

### [Basic Principle of Coming-Out Object Setting Process Including Particular Point Identification Process]

When the blind spot region is detected, the driving assistance controller 116 may execute the coming-out object setting process of setting the coming-out object OB, based on an assumption that the coming-out object OB is present that comes out from the detected blind spot region if the own vehicle M travels at the current speed and arrives at the blind spot region.

For example, the driving assistance controller 116 may set, as the position and the movement speed of the coming-out object OB, a position and a movement speed that are assumed in advance and are, for example, assumable based on the current position and the speed of the own vehicle M.

Further, as the coming-out object setting process, the driving assistance controller 116 may identify the current speed and the current position of the own vehicle M, and may also identify information regarding the coming-out object OB based on the above-described blind spot region related information. Hereinafter, the current speed of the own vehicle M may be referred to as a “current own vehicle speed”.

For example, the driving assistance controller 116 may identify, as the information regarding the coming-out object OB, a kind of the coming-out object OB, an initial position of the coming-out object OB, and an initial movement speed of the coming-out object OB. Hereinafter, the initial position of the coming-out object OB may be referred to as a “movement start position”, and the initial movement speed of the coming-out object OB may be referred to as an “assumed speed”.

In addition, the driving assistance controller 116 may execute the particular point identification process of identifying, in a process of identifying the position of the coming-out object OB as the information regarding the coming-out object OB, the particular point at which the coming-out object OB and the own vehicle M can come into contact with each other.

In some example embodiments, the driving assistance controller 116 may execute the particular point identification process by a process different from the coming-out object setting process.

### [Identification of Kind of Coming-Out Object]

The driving assistance controller 116 may identify the kind of the coming-out object OB based on the blind spot region related information detected as described above, and may identify the movement speed of the coming-out object OB based on the kind of the coming-out object OB.

For example, the data storage 142 may contain table data in which the kind of the coming-out object OB is defined in association with the blind spot region related information. The driving assistance controller 116 may refer to the table data based on the blind spot region related information to identify the kind of the coming-out object OB.

For example, when the blind spot region is at an intersection with no traffic light, the driving assistance controller 116 may set a bicycle as the coming-out object OB. When the blind spot region is created by an automobile as an obstacle, the driving assistance controller 116 may set a pedestrian as the coming-out object OB.

### [Identification of Assumed Start Speed of Coming-Out Object]

The data storage 142 may contain an assumed start speed as an initial value of the coming-out object for each kind of the coming-out object OB. The driving assistance controller 116 may refer to the table data based on the identified kind of the coming-out object OB to identify the assumed start speed of the coming-out object OB.

For example, the driving assistance controller 116 may identify “5 km/h” as the assumed start speed for a pedestrian, and may identify “15 km/h” as the assumed start speed for a bicycle.

### [Identification of Particular Point Based on Execution of Particular Point Identification Process]

The driving assistance controller 116 may identify a region that extends from the blind spot region and crosses the traveling direction of the own vehicle M, has a width similar to that of the blind spot region, and overlaps with a region which the own vehicle M travels and passes through. Hereinafter, such a region may be referred to as an “overlapping region”. The width may be a length in a depth direction with respect to the traveling direction.

Further, the driving assistance controller 116 may execute a particular point specification process of identifying a particular point with a risk of contact between the coming-out object OB and the own vehicle M in the identified overlapping region.

For example, as illustrated in FIG. 4, as the particular point specification process, the driving assistance controller 116 may identify the overlapping region, and may also identify, as the particular point, a point that is closest to the own vehicle M in the traveling direction of the own vehicle M in the overlapping region or a point determined based on, for example, the kind of the blind spot region.

### [Identification of Movement Start Position of Coming-Out Object]

As illustrated in FIG. 4, the driving assistance controller 116 may calculate the distance L from the current position of the own vehicle M to the particular point, based on the current position of the own vehicle M identified by the surrounding environment detector 112 and the identified particular point.

Further, the driving assistance controller 116 may detect the current speed of the own vehicle M, i.e., the current own vehicle speed, based on the data transmitted from the vehicle operation/behavior sensor 27, as illustrated in FIG. 4.

In this case, the driving assistance controller 116 may calculate an estimated time at which the own vehicle M is estimated to arrive at the particular point, based on the calculated distance L from the current position of the own vehicle M to the blind spot region, and the current own vehicle speed. The driving assistance controller 116 may assume that the coming-out object OB is to come out to the particular point at the calculated estimated time.

Further, as illustrated in FIG. 4, the driving assistance controller 116 may identify a position of the coming-out object OB at the current time in the blind spot region, based on the calculated estimated time and the assumed start speed of the coming-out object OB identified as described above.

For example, the driving assistance controller 116 may identify the position of the coming-out object OB at the current time in the blind spot region by calculating backward based on the calculated estimated time and the assumed start speed of the coming-out object OB.

### [B4. 4: Upper-Limit Speed Setting Process]

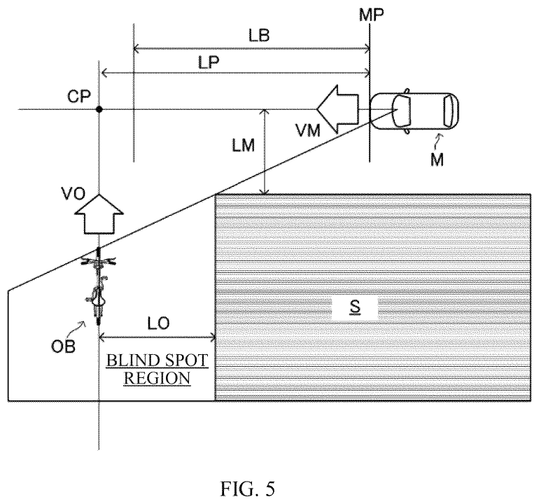

Referring to FIG. 5, a description is provided next of an upper-limit speed setting process to be executed by the vehicle control system 10 of the example embodiment.

FIG. 5 is a diagram for describing the upper-limit speed setting process to be executed by the vehicle control system 10 of the example embodiment.

When identifying the coming-out object OB, the driving assistance controller 116 may execute the upper-limit speed setting process of setting the upper-limit speed that is a speed that the speed of the own vehicle M reaches by deceleration and that allows for avoidance of the contact between the own vehicle M and the coming-out object OB as the virtual object at the particular point.

For example, as the upper-limit speed setting process, the driving assistance controller 116 may set, as the upper-limit speed, a speed that allows for emergency stop of the own vehicle M at the particular point by an emergency stop braking operation as a driving assistance operation. The emergency stop braking operation may be an operation of performing emergency stop of the own vehicle M regardless of whether a braking operation is performed by the driver.

Further, the driving assistance controller 116 may refer to the reference data stored in the data storage 142 based on the blind spot region related information detected as described above, and may calculate and set the upper-limit speed of the own vehicle M in the corresponding blind spot region, for example, by a calculation method exemplified below with reference to FIG. 5.

For example, the driving assistance controller 116 may refer to the reference data based on the blind spot region related information, may identify the kind of the virtual coming-out object OB, and may refer to a speed VO and a position (a distance) LO of the virtual coming-out object OB at a time when the virtual coming-out object OB is to come out from the blind spot region.

Further, the driving assistance controller 116 may identify a distance LM, for example, based on the blind spot region related information and the information regarding the surrounding environment. The distance LM may be a distance in a lateral direction from the obstacle creating the blind spot region to the position at which the own vehicle M is traveling. In the example case illustrated in FIG. 5, the obstacle may be a blocking object S.

Further, the driving assistance controller 116 may identify an estimated contact point at which the coming-out object OB and the own vehicle M are to come into contact in the particular point, based on the distance LM and the position LO described above.

Further, the driving assistance controller 116 may identify a detection point MP, related to the own vehicle M, at which the coming-out object OB is detected, and may identify a distance LP from the detection point MP to the estimated contact point CP at which the own vehicle M and the coming-out object OB are to come into actual contact with each other. The detection point MP may be a point at which an instruction for a control of emergency stop braking of the own vehicle M is to be given.

Thereafter, the driving assistance controller 116 may identify a distance LB for braking of the own vehicle M by the emergency stop braking, may compare the distance LB and the distance LP with each other to calculate the upper-limit speed.

For example, based on an assumption that the coming-out object OB is actually present, the detection point MP of the coming-out object OB, i.e., the point at which the instruction for the control of emergency stop braking of the own vehicle M is to be given, may be a point at which appearance of the coming-out object OB from an end SO of the obstacle, i.e., the blocking object S, is recognized.

Therefore, the driving assistance controller 116 may identify the distance LB based on a development time T and a speed VM of the own vehicle M, on an assumption that the emergency stop braking exhibits a maximum performance having a deceleration rate AB. The development time T may be a time from a timing when the instruction is given for the control of emergency stop braking of the own vehicle M to a timing at which the emergency stop braking starts operating.

As illustrated in FIG. 5, if “distance LP>distance LB” holds, the contact between the own vehicle M and the coming-out object OB may be avoidable. Therefore, the driving assistance controller 116 may calculate, as the upper-limit speed, the speed VM of the own vehicle M that satisfies the above-described condition.

In FIG. 5, when LO is 1 m, VO is 15 km/h, LM is 2.5 m, AB is 4.9 m/s², and T is 0.2 s, the driving assistance controller 116 may obtain “20 km/h” as the upper-limit speed at which the condition “distance LP>distance LB” holds.

### [B4. 5: Speed Change Plan Setting Process]

A description is provided next of the speed change plan setting process to be executed by the vehicle control system 10 of the example embodiment.

The driving assistance controller 116 may execute the speed change plan setting process of setting a speed change plan that defines a speed based on a distance that the own vehicle M has traveled, using the distance L from the current position of the own vehicle M to the particular point as a reference. For example, the speed change plan may represent a path of a speed change. Hereinafter, the distance that the own vehicle M has traveled may be referred to as an “own vehicle traveling distance”.

For example, the driving assistance controller 116 may set one or more speed change plans that each define a speed based on a speed change of the own vehicle M from the current position of the own vehicle M to the particular point, and are each adapted to allowing the own vehicle M to pass the particular point at a speed lower than the upper-limit speed.

For example, the driving assistance controller 116 may calculate, as a path of speed, how the speed is to change for deceleration, based on the distance L from the current position of the own vehicle M to the particular point. The deceleration may be to be performed from the current own vehicle speed to cause the own vehicle M to travel at the upper-limit speed at the particular point, without much difficulty and without causing discomfort to an occupant including the driver.

For example, the driving assistance controller 116 may set, as the path of a speed change, a speed for each predetermined own vehicle traveling distance based on the current position of the own vehicle M, the distance L from the current position of the own vehicle M to the particular point, the current speed of the own vehicle M (i.e., the current own vehicle speed), and the upper-limit speed.

A detailed description is omitted of a method of performing the deceleration based on the distance for a target speed as the upper-limit speed without much difficulty and without causing discomfort to the occupant in the speed change plan setting process of the example embodiment, because such a method may be a known technique.

### [B4. 6: Visualization Control Process]

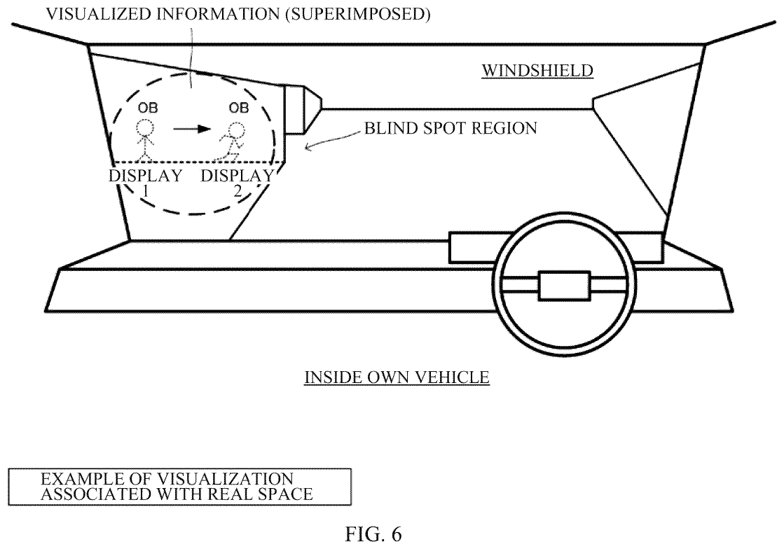

Referring to FIGS. 6 to 9, a description is provided next of a visualization control process to be executed by the vehicle control system 10 of the example embodiment.

FIGS. 6 to 9 are each a diagram for describing the visualization control process to be executed by the vehicle control system 10 of the example embodiment.

### [Basic Principles]

When the speed change plan is set as described above, the driving assistance controller 116 may execute the visualization control process based on a result of a comparison between the current own vehicle speed of the own vehicle M and the speed defined by the speed change plan. Hereinafter, the speed defined by the speed change plan may be referred to as a “planned speed”.

For example, as the visualization control process, the driving assistance controller 116 may execute a process adapted to allowing the driver to recognize the risk of the contact between the own vehicle M and the coming-out object OB based on the above-described result of the comparison at each predetermined timing or each time the own vehicle M travels a predetermined distance.

For example, when executing the visualization control process, the driving assistance controller 116 may execute a planned speed determination process of determining whether the current own vehicle speed is higher than, is lower than, or matches the planned speed, while determining whether the current own vehicle speed is lower than the upper-limit speed.

Further, in conjunction with the notification controller 117, the driving assistance controller 116 may execute the visualization control process of visualizing the coming-out object OB in association with the blind spot region, based on a result of the planned speed determination process, in order to allow the driver to recognize the risk of the contact between the own vehicle M and the coming-out object OB.

For example, when visualizing the coming-out object OB under the control by the driving assistance controller 116, the notification controller 117 may execute a display control process adapted to visualizing the coming-out object OB in association with the real space or visualizing the coming-out object OB on the map data.

In addition, the notification controller 117 may execute the display control process of changing the method of visualizing the coming-out object OB, based on the result of the determination as to whether the current own vehicle speed is higher than, is lower than, or matches the planned speed.

For example, the notification controller 117 may change the method of visualizing the coming-out object OB when the current own vehicle speed is determined as being higher than the planned speed, when the current own vehicle speed is determined as matching the planned speed, or when the current own vehicle speed is determined as being lower than the planned speed.

### [Planned Speed Determination Process]

The driving assistance controller 116 may execute the planned speed determination process of comparing the planned speed at the corresponding point and the current own vehicle speed with each other and determining whether the current own vehicle speed is higher than, is lower than, or matches the planned speed, at each predetermined timing or each time the own vehicle M travels the predetermined distance.

Further, the driving assistance controller 116 may determine whether the current own vehicle speed is higher or lower than a speed that is the same as the planned speed or a speed that is regarded as substantially the same as the planned speed.

In addition, the driving assistance controller 116 may determine whether the current own vehicle speed matches the speed that is the same as the planned speed or the speed that is regarded as substantially the same as the planned speed.

For example, the driving assistance controller 116 may use, as the speed that is regarded as substantially the same as the planned speed, for example, a speed within a predetermined range of the speed that is the same as the planned speed, or an average speed in a certain period. For example, the predetermined range may be ±1 km/h. For example, the certain period may be 1 second.

In some example embodiments, upon executing the planned speed determination process, if the current own vehicle speed is already lower than the upper-limit speed, the driving assistance controller 116 may determine that the risk of the contact between the own vehicle M and the coming-out object OB at the particular point has been eliminated or reduced, and may stop the display control process.

### [Display Control Process]

Each time the planned speed determination process is executed, the notification controller 117 may execute, as the display control process, a process of visualizing the coming-out object OB as the virtual object in the real space in association with the real space or visualizing the coming-out object OB as the virtual object on the map data in association with the map data, in order to allow the driver to recognize the risk of the contact between the own vehicle M and the coming-out object OB.

For example, when executing the display control process, the notification controller 117 may change the method of visualizing (the method of displaying) the coming-out object OB based on the result of the determination in the planned speed determination process.

The notification controller 117 may use, in the visualization method, a displayed color of the coming-out object OB; or the moving speed of the coming-out object OB including a corresponding relationship between the coming-out object OB and the blind spot region or the particular point.

For example, the notification controller 117 may visualize the visualized information related to the coming-out object OB at a portion forming the blind spot region in the real space, to allow the driver to virtually view the coming-out object OB, at each predetermined timing or each time the own vehicle M travels the predetermined distance.

For example, as illustrated in FIG. 6, when the driver looks in the traveling direction through a transparent object, the notification controller 117 may display the coming-out object OB on the transparent object to thereby visualize the coming-out object OB. Non-limiting examples of the transparent object may include the windshield and eyeglasses.

Note that FIG. 6 illustrates an example case where the coming-out object OB is visualized in association with the real space viewable from the own vehicle M through the windshield. In this example case, the coming-out object OB may be visualized and superimposed on a region corresponding to an obstacle forming the blind spot region in the real space.

Further, FIG. 6 illustrates an example case where the movement speed and the position of the coming-out object OB is changed, as with in FIG. 3. In this example case, the display of the coming-out object OB may be changed from display 1 to display 2.

In some example embodiments, the notification controller 117 may visualize the coming-out object OB by superimposing and displaying the visualized information related to the coming-out object OB on a display region in which the blind spot region on the map data is formed, at each predetermined timing or each time the own vehicle M travels the predetermined distance.

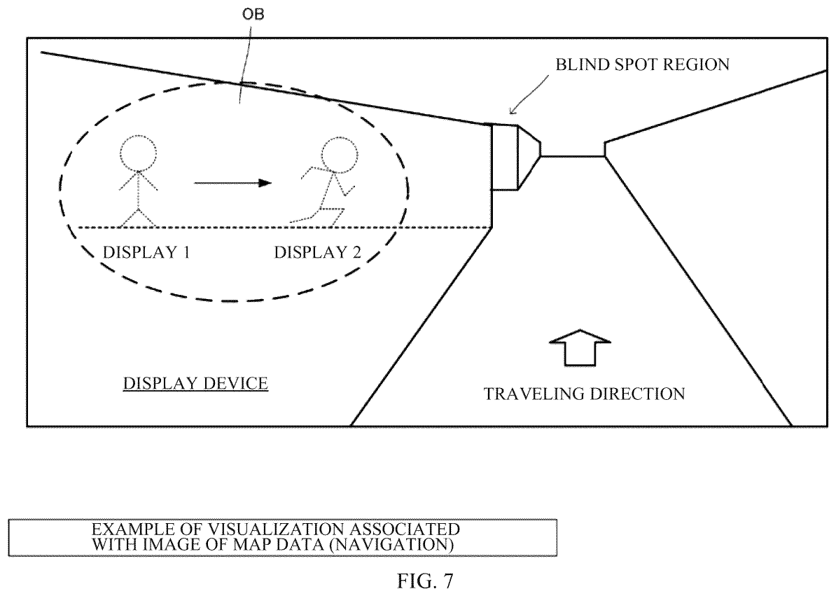

In this case, for example, as illustrated in FIG. 7, the notification controller 117 may superimpose and display the visualized information related to the coming-out object OB on the display region in which the blind spot region on the map data is formed, on the display device displaying a map. The map may be, for example, a map of the navigation system. The map data may be two-dimensional map data or three-dimensional map data, for example.

Note that FIG. 7 illustrates an example case where the coming-out object OB is visualized in association with an image of the map data (navigation). In this example case, the coming-out object OB may be visualized and superimposed on the region corresponding to the obstacle forming the blind spot region in the map data.

Further, FIG. 7 illustrates an example case where the movement speed and the position of the coming-out object OB is changed, as with in FIG. 3. In this example case, the display of the coming-out object OB may be changed from display 1 to display 2.

### [Display Control Process: Control of Display Color of Coming-Out Object]

When the display color of the coming-out object OB is to be controlled, the notification controller 117 may change the display color of the coming-out object OB based on a difference between the planned speed and the current own vehicle speed at the current position of the own vehicle M, as the display control process.

For example, based on the result of the determination of the current own vehicle speed of the own vehicle M and the corresponding planned speed, the notification controller 117 may change the display color of the coming-out object OB based on a difference between the planned speed and the current own vehicle speed at the current position of the own vehicle M.

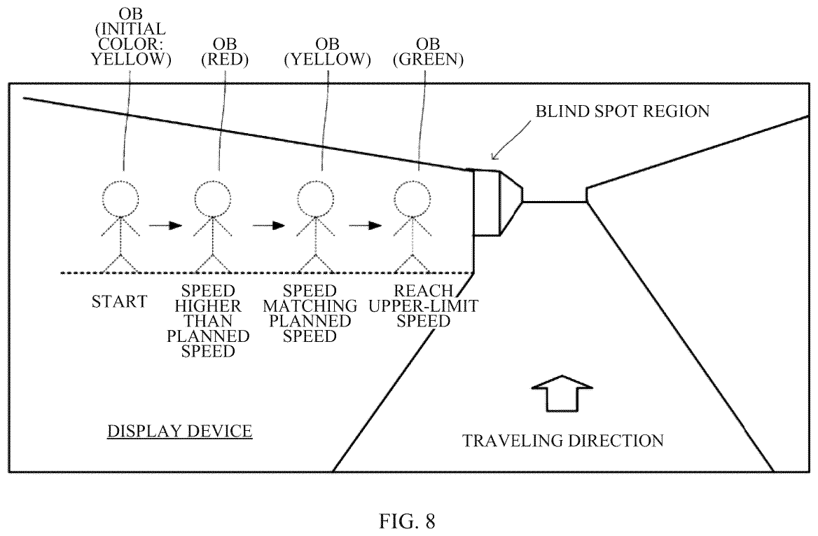

For example, when the own vehicle speed is higher than the corresponding planned speed, as illustrated in FIG. 8, the notification controller 117 may visualize the coming-out object OB with a color indicating a high risk of the contact between the own vehicle M and the coming-out object OB, as the control of the display color in the display control process. The color indicating the high risk of the contact between the own vehicle M and the coming-out object OB may be red, for example.

In this case, because a possibility of the contact between the own vehicle M and the coming-out object OB at the particular point is assumed to be high, the notification controller 117 may display the coming-out object OB in a color that draws more attention of the driver.

For example, when the own vehicle speed matches the corresponding planned speed, as illustrated in FIG. 8, the notification controller 117 may visualize the coming-out object OB with a color indicating a low risk of the contact between the own vehicle M and the coming-out object OB. The color indicating the low risk of the contact between the own vehicle M and the coming-out object OB may be yellow, for example.

In this case, because it is estimated that the own vehicle speed is to be the upper-limit speed and is also to be the speed allowing for emergency stop of the own vehicle M at the particular point, the notification controller 117 may display the coming-out object OB in a color indicating a low risk.

For example, when the own vehicle speed is lower than the corresponding planned speed, as illustrated in FIG. 8, the notification controller 117 may visualize the coming-out object OB in a color indicating substantially no risk of the contact between the own vehicle M and the coming-out object OB. The color indicating substantially no risk of the contact between the own vehicle M and the coming-out object OB may be green, for example.

In this case, because it is estimated that the contact between the own vehicle M and the coming-out object OB at the particular point is avoided, the notification controller 117 may display the coming-out object OB in a color indicating that the coming-out object OB is safe for the driver.

Note that FIG. 8 illustrates an example case where the coming-out object OB is displayed in yellow as an initial color, together with a map image, on the display device at the start of the driving assistance control process.

In this example case illustrated in FIG. 8, the display color of the coming-out object OB changes from red, yellow, to green based on the result of the determination in the planned speed determination process, after the driving assistance control process is started.

In some example embodiments, when the current own vehicle speed is lower than the planned speed defined by the speed change plan, for example, when the current own vehicle speed is lower than the upper-limit speed, the notification controller 117 may stop the visualization control process and end the driving assistance control process based on the risk of the contact between the own vehicle M and the coming-out object OB.

### [Display Control Process: Control of Movement Speed of Coming-Out Object]

When controlling the movement speed of the coming-out object OB as the display control process, the notification controller 117 may change the movement speed of the coming-out object OB from the assumed speed determined at the time when the coming-out object OB is identified, based on the difference between the planned speed and the current own vehicle speed at the current position of the own vehicle M.

That is, in this case, based on the result of the determination of the current own vehicle speed and the corresponding planned speed, the notification controller 117 may change the movement speed of the coming-out object OB, based on the difference between the planned speed and the current own vehicle speed at the current position of the own vehicle M.

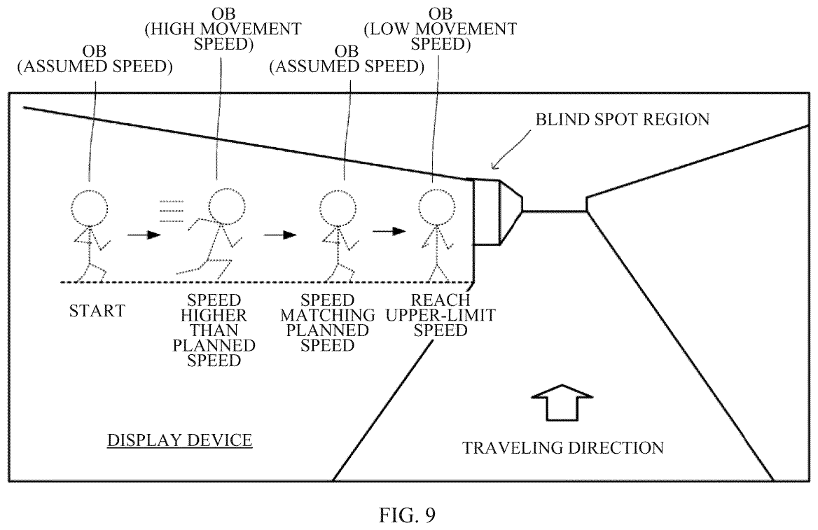

For example, when the own vehicle speed is higher than the corresponding planned speed, as illustrated in FIG. 9, the notification controller 117 may visualize the coming-out object OB having the movement speed higher than the assumed speed, to thereby indicate a high risk of the contact between the own vehicle M and the coming-out object OB.

That is, in this case, because it is estimated that the possibility of the contact between the own vehicle M and the coming-out object OB at the particular point is high, the notification controller 117 may increase the movement speed of the coming-out object OB moving toward the particular point to be higher than the assumed speed and thus display the coming-out object OB with the increased movement speed.

For example, when the planned speed is 30 km/h and the current own vehicle speed is 40 km/h, the difference in speed may be at a rate of 1.33. Therefore, the notification controller 117 may display the coming-out object OB with a speed 1.33 times higher than the assumed speed or the previous speed.

When the own vehicle speed matches the corresponding planned speed, as illustrated in FIG. 9, the notification controller 117 may visualize the coming-out object OB still having the assumed speed in order to indicate a low risk of the contact between the own vehicle M and the coming-out object OB.

In this case, because it is estimated that the own vehicle speed is to be the upper-limit speed and is also to be the speed allowing for emergency stop of the own vehicle M at the particular point, the notification controller 117 may display the coming-out object OB, maintaining the movement speed at the time of the start of the movement.

Further, when the own vehicle speed is lower than the corresponding planned speed, as illustrated in FIG. 9, the notification controller 117 may visualize the coming-out object OB with a speed lower than the assumed speed in order to indicate no or a little risk of the contact between the own vehicle M and the coming-out object OB.

In this case, because it is estimated that the contact between the own vehicle M and the coming-out object OB is avoided at the particular point, the notification controller 117 may display the coming-out object OB with the speed lower than the movement speed at the time of the start of the movement.

Note that FIG. 9 illustrates an example case where the coming-out object OB is displayed, together with the map image, on the display device, with the assumed speed at the time of the start of the driving assistance control process.

In the example case illustrated in FIG. 9, the movement speed of the coming-out object OB changes from the assumed speed to the higher movement speed, the assumed speed, and the lower movement speed based on the result of the determination in the planned speed determination process after the start of the driving assistance control process.

Further, in some example embodiments, when the current own vehicle speed is lower than the planned speed defined by the speed change plan, for example, when the current own vehicle speed is lower than the upper-limit speed, the notification controller 117 may stop the visualization control process and end the driving assistance control process based on the risk of the contact between the own vehicle M and the coming-out object OB.

In some example embodiments, the notification controller 117 may execute, as the display control process, a control of the movement speed of the coming-out object OB in addition to the above-described control of the display color of the coming-out object OB.

In some example embodiments, the notification controller 117 may control the display state or the visualized state of the coming-out object OB instead of or in addition to the movement speed described above, as the display control process.

For example, in this case, when the own vehicle speed is higher (or lower) than the corresponding planned speed, the notification controller 117 may change the state of the coming-out object OB to a state that allows the driver to recognize the movement speed of the coming-out object OB as a higher (or lower) movement speed, as the display control process.

For example, when the coming-out object OB is a pedestrian and when the own vehicle speed is higher (or lower) than the corresponding planned speed, the notification controller 117 may change the state of the coming-out object OB to a running state (or a slower walking state). When the own vehicle speed matches the corresponding planned speed, the notification controller 117 may change the state of the coming-out object OB to a walking state at the assumed speed.

### B5: Operation of Example Embodiment

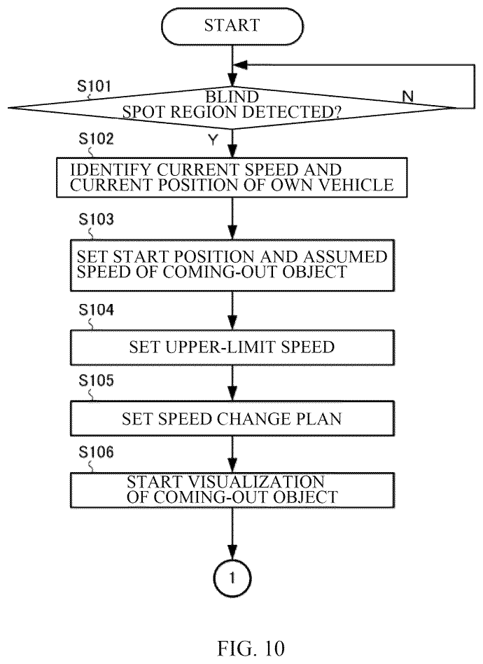

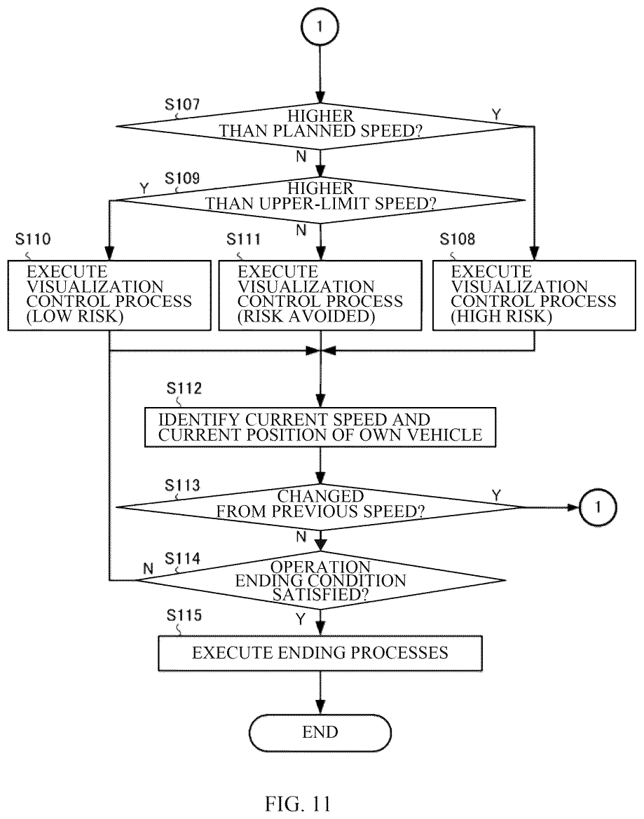

Referring to FIGS. 10 and 11, a description is provided next of an operation in the driving assistance control process based on the risk of the contact between the own vehicle M and the coming-out object OB, to be executed by the driving assistance control apparatus 100 of the example embodiment.

FIGS. 10 and 11 are flowcharts illustrating the operation in the driving assistance control process based on the risk of the contact between the own vehicle M and the coming-out object OB, to be executed by the driving assistance control apparatus 100 of the example embodiment.

In this operation, it may be assumed that the driver has already been driving the own vehicle M, and the surrounding environment detector 112 has already been detecting the blind spot region in the traveling direction of the own vehicle M at appropriate timings. It may also be assumed that, when the blind spot region is detected, one speed change plan is to be set.

First, the driving assistance controller 116 may determine whether the blind spot region present in the traveling direction of the own vehicle M is detected by the surrounding environment detector 112 (step S101). If the driving assistance controller 116 determines that the blind spot region is not detected (step S101: N), the driving assistance controller 116 may repeat the process in step S101. If the driving assistance controller 116 determines that the blind spot region is detected (step S101: Y), the driving assistance controller 116 may detect the current speed of the own vehicle M, i.e., the current own vehicle speed, and the current position of the own vehicle M (step S102).

For example, the driving assistance controller 116 may detect the current own vehicle speed based on the data from the vehicle operation/behavior sensor 27, and may detect the current position of the own vehicle M by the surrounding environment detector 112.

Thereafter, based on the detected current own vehicle speed, the identified current position of the own vehicle M, and the detected position of the blind spot region, the driving assistance controller 116 may tentatively determine the start position and the movement speed (the assumed speed) of the coming-out object OB that is possibly to come out from the blind spot region (step S103).

Thereafter, the driving assistance controller 116 may execute the upper-limit speed setting process of setting the upper-limit speed of the own vehicle M (step S104). The upper-limit speed may be a speed that the speed of the own vehicle M reaches by deceleration from the detected speed of the own vehicle M and that allows for avoidance of the contact between the own vehicle M and the coming-out object OB at the particular point where the own vehicle M and the coming-out object OB can come into contact with each other.

Thereafter, the driving assistance controller 116 may execute the speed change plan setting process of setting the speed change plan that allows the own vehicle M to pass the particular point at a speed lower than the upper-limit speed (step S105).

Thereafter, the driving assistance controller 116 may cause the notification controller 117 to start the visualization control process of visualizing the coming-out object OB in association with the real space or on the map data in association with the map data, based on the set position and the set movement speed (step S106).

Thereafter, the driving assistance controller 116 may execute the planned speed determination process of determining whether the detected speed of the own vehicle M is higher than the speed that is defined by the speed change plan and is based on the distance to the particular point based on the current position of the own vehicle M, i.e., the planned speed (step S107).

In this case, if the driving assistance controller 116 determines that the speed of the own vehicle M is higher than the planned speed (step S107: Y), the driving assistance controller 116 may cause the process to proceed to step S108. If the driving assistance controller 116 determines that the speed of the own vehicle M is not higher than the planned speed (step S107: N), the driving assistance controller 116 may cause the process to proceed to step S109.

Thereafter, when determining that the speed of the own vehicle M is higher than the planned speed, the driving assistance controller 116 may cause the notification controller 117 to execute the visualization control process, for a high risk, of allowing the driver to recognize the high risk of the contact between the own vehicle M and the coming-out object OB (step S108).

For example, under the control of the driving assistance controller 116, the notification controller 117 may execute, as the visualization control process, the display control process of visualizing one or both of the color indicating the high risk of the contact between the own vehicle M and the coming-out object OB, and the movement speed of the coming-out object OB. For example, the color indicating the high risk of the contact between the own vehicle M and the coming-out object OB may be red. For example, the movement speed of the coming-out object OB may be the speed of running.

In contrast, when determining that the speed of the own vehicle M is not higher than the planned speed, the driving assistance controller 116 may determine whether the detected speed of the own vehicle M is higher than the upper-limit speed (step S109).

In this case, if the driving assistance controller 116 determines that the detected speed of the own vehicle M is higher than the upper-limit speed (step S109: Y), the driving assistance controller 116 may cause the process to proceed to step S110. If the driving assistance controller 116 determines that the detected speed of the own vehicle M is not higher than or is lower than the upper-limit speed (step S109: N), the driving assistance controller 116 may cause the process to proceed to step S111.

Thereafter, when determining that the speed of the own vehicle M is higher than the upper-limit speed, the driving assistance controller 116 may cause the notification controller 117 to execute the visualization control process, for a low risk, of allowing the driver to recognize a low risk of the contact between the own vehicle M and the coming-out object OB as the virtual object (step S110).

For example, under the control of the driving assistance controller 116, the notification controller 117 may execute, as the visualization control process, the display control process of visualizing one or both of the color indicating the low risk of the contact between the own vehicle M and the coming-out object OB, and the movement speed of the coming-out object OB. For example, the color indicating the low risk of the contact between the own vehicle M and the coming-out object OB may be yellow. For example, the movement speed of the coming-out object OB may be the assumed speed identified first.

When determining that the speed of the own vehicle M is not higher than or is lower than the upper-limit speed, the driving assistance controller 116 may cause the notification controller 117 to execute the visualization control process of allowing the driver to recognize no or a little risk of the contact of the own vehicle M and the coming-out object OB (step S111).

For example, under the control of the driving assistance controller 116, the notification controller 117 may execute, as the visualization control process, the display control process of visualizing one or both of the color indicating no or a little risk of the contact between the own vehicle M and the coming-out object OB, and the movement speed of the coming-out object OB. For example, the color indicating no or a little risk of the contact between the own vehicle M and the coming-out object OB may be green. For example, the movement speed of the coming-out object OB may be the speed of slow walking.

Thereafter, the driving assistance controller 116 may detect the current speed of the own vehicle M, i.e., the current own vehicle speed, based on the data from the vehicle operation/behavior sensor 27, and may identify the current position of the own vehicle M identified by the surrounding environment detector 112 (step S112).

Thereafter, the driving assistance controller 116 may determine whether the detected current own vehicle speed has changed from the previously detected speed of the own vehicle M (step S113).

In this case, if the driving assistance controller 116 determines that the speed of the own vehicle M has changed (step S113: Y), the driving assistance controller 116 may cause the process to proceed to step S107. If the driving assistance controller 116 determines that the speed of the own vehicle M has not changed (step S113: N), the driving assistance controller 116 may cause the process to proceed to step S114.

Thereafter, the driving assistance controller 116 may determine whether an operation ending condition is satisfied (step S114). The operation ending condition may include, for example, arrival of the own vehicle M at the particular point.

In this case, if the driving assistance controller 116 determines that the operation ending condition is not satisfied (step S114: N), the driving assistance controller 116 may cause the process to proceed to step S112.

In contrast, if the driving assistance controller 116 determines that the operation ending condition is satisfied (step S114: Y), the driving assistance controller 116 may execute various processes adapted to ending the visualization control process of the coming-out object OB as the virtual object performed by the notification controller 117 (step S115), and may end this operation. Hereinafter, the various processes adapted to ending the visualization control process of the coming-out object OB as the virtual object may be referred to as “ending processes”.

### B6: Modifications

### [B6. 1: Modification 1: Intermittent Display of Coming-Out Object]

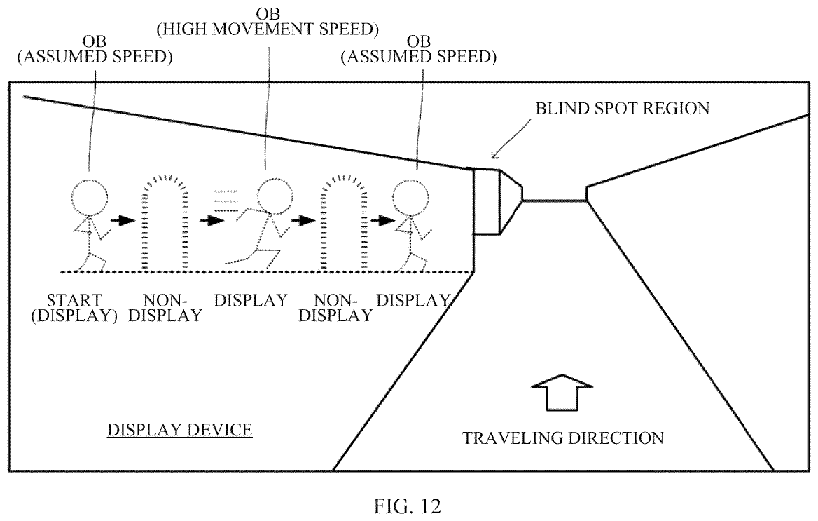

Referring to FIG. 12, a description is provided next of intermittent display of the coming-out object OB, as Modification 1 of the example embodiment.

FIG. 12 is a diagram for describing the intermittent display of the coming-out object OB according to Modification 1.

According to Modification 1, in the above-described example embodiment, when the visualization control process is executed, a display control process may be executed in which the coming-out object OB is intermittently visualized in association with the real space or intermittently displayed on the map data.

That is, in Modification 1, during execution of the driving assistance control process based on the risk of the contact between the own vehicle M and the coming-out object OB, the coming-out object OB displayed to be visualized may be visualized intermittently. This makes it possible to more reliably allow the driver to recognize the coming-out object OB.

In Modification 1, it is also possible to reduce the strangeness caused, when the display of the coming-out object OB is performed, by executing the planned speed determination process and changing the displayed position of the coming-out object OB.

In this case, the driving assistance controller 116 may cause the notification controller 117 to intermittently visualize the coming-out object OB in association with the real space or to intermittently visualize the coming-out object OB on the map data, as the display control process.

For example, the notification controller 117 may execute an intermittent display control process of alternately repeating superimposed display and non-display of the visualized information related to the coming-out object OB at each predetermined timing or each time the own vehicle M travels the predetermined distance.

For example, as illustrated in FIG. 12, each time the planned speed determination process is executed, the notification controller 117 may display the coming-out object OB for a certain period, with one or both of the identified display color and the identified movement speed, and thereafter, refrain from displaying the coming-out object OB until the next planned speed determination process is executed.

Note that FIG. 12 illustrates an example in which after the display of the coming-out object OB is started, the coming-out object OB is displayed, after a non-display period, at a new position and with a new movement speed each time the movement speed of the coming-out object OB changes.

In some example embodiments, the notification controller 117 may display the coming-out object OB for a certain period, with one or both of the identified display color and the identified movement speed at a predetermined timing, instead of each time the planned speed determination process is executed.

When intermittently visualizing the coming-out object OB in association with the real space, the notification controller 117 may intermittently visualize the coming-out object OB by intermittently displaying the coming-out object OB on a transparent object when the driver looks in the traveling direction through the transparent object. Non-limiting examples of the transparent object may include the windshield and the eyeglasses.

When intermittently visualizing the coming-out object OB on the map data, the notification controller 117 may intermittently display the visualized information related to the coming-out object OB, superimposing the visualized information related to the coming-out object OB on the display region, of the display device, in which the blind spot region is formed on the map data. The display device may display the map such as the map of the navigation.

### [B6. 2: Modification 2: Various Processes by Management Server]

A description is provided next, as Modification 2 of the example embodiment, of a case where a management server executes a portion or all of the driving assistance control process based on the risk of the contact between the own vehicle M and the coming-out object OB.

In the above-described example embodiment, the driving assistance control apparatus 100 may execute the various processes described above. However, in some example embodiments, the management server communicatively coupled to the driving assistance control apparatus 100 may execute a portion of the above-described various processes, or may execute all of the processes except for the process that the management server is not able to execute. The process that the management server is not able to execute may be, for example, the display control process.

### C: Other Modifications

An embodiment of the disclosure is not limited to the example embodiments described above, and various modifications may be made. For example, terms cited as broader or synonymous terms in one description of the specification or the drawings may be used as broader or synonymous terms in another description of the specification or the drawings.

Some example embodiments of the disclosure include configurations substantially similar to the configuration described above in the example embodiment. For example, some embodiments of the disclosure include configurations adapted to execution of a similar operation; using a similar method and achieving a similar result; or having similar purpose and effect. In addition, some example embodiments of the disclosure may include configurations in which non-essential portion of the configuration described above in the example embodiment is replaced. In addition, some example embodiments of the disclosure may include a configuration achieving operations and effects similar to those of the configuration described above in the example embodiment, and a configuration achieving a purpose similar to that of the configuration described above in the example embodiment. Some example embodiments of the disclosure may include a configuration in which a publicly known technique is added to the configuration described above in the example embodiment.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

With any of a driving assistance apparatus, a vehicle, a non-transitory recording medium containing a computer program, and a driving assistance method according to an embodiment of the disclosure, it is possible to allow a driver who drives a vehicle to recognize a risk of contact between the vehicle and an object that is possibly to come out from a blind spot region, and to guide a speed of the vehicle to a safer speed. It is therefore possible to reduce the risk of the contact around the blind spot region.

The processing device 110 illustrated in FIG. 1 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the processing device 110 illustrated in FIG. 1. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the processing device 110 illustrated in FIG. 1.

1. A driving assistance apparatus configured to assist driving of a vehicle, the driving assistance apparatus comprising:
one or more processors; and
one or more memories communicably coupled to the one or more processors, wherein
the one or more processors are configured to:
set a position and a movement speed of a virtual object that is possibly to come out from a blind spot region present in a traveling direction of the vehicle;
execute a particular point identification process of identifying, as a particular point, a point at which the traveling direction of the vehicle and a moving direction of the virtual object intersect;
execute an upper-limit speed setting process of setting, as an upper-limit speed, a speed that a speed of the vehicle reaches by deceleration and that is of an upper limit to allow for avoidance of contact between the vehicle and the virtual object at the particular point;
execute a speed change plan setting process of setting one or more speed change plans based on a current position of the vehicle, a distance from the current position of the vehicle to the particular point, a current speed of the vehicle, and the upper-limit speed, the one or more speed change plans each defining a speed change of the vehicle from the current position of the vehicle to the particular point, the one or more speed change plans each being configured to allow the vehicle to pass the particular point at a speed lower than the upper-limit speed; and
execute a visualization control process of visualizing the virtual object when the speed of the vehicle is determined as being higher than a speed defined by the one or more speed change plans, the visualization control process being configured to allow a driver who drives the vehicle to recognize a risk of the contact between the vehicle and the virtual object.

2. The driving assistance apparatus according to claim 1, wherein the one or more processors are configured to, as the visualization control process, change a method of visualizing the virtual object among a case where the speed of the vehicle is determined as being higher than the speed defined by the one or more speed change plans, a case where the speed of the vehicle is determined as matching the speed defined by the one or more speed change plans, and a case where the speed of the vehicle is determined as being lower than the speed defined by the one or more speed change plans.

3. The driving assistance apparatus according to claim 1, wherein the one or more processors are configured to stop the visualization control process when the speed of the vehicle is lower than the speed defined by the one or more speed change plans.

4. The driving assistance apparatus according to claim 1, wherein the one or more processors are configured to, as the visualization control process, intermittently visualize the virtual object in association with a real space or intermittently visualize the virtual object on map data.

5. A vehicle comprising
a driving assistance apparatus configured to assist driving of the vehicle, the driving assistance apparatus being configured to:
set a position and a movement speed of a virtual object that is possibly to come out from a blind spot region present in a traveling direction of the vehicle;
execute a particular point identification process of identifying, as a particular point, a point at which the traveling direction of the vehicle and a moving direction of the virtual object intersect;
execute an upper-limit speed setting process of setting, as an upper-limit speed, a speed that a speed of the vehicle reaches by deceleration and that is of an upper limit to allow for avoidance of contact between the vehicle and the virtual object at the particular point;
execute a speed change plan setting process of setting one or more speed change plans based on a current position of the vehicle, a distance from the current position of the vehicle to the particular point, a current speed of the vehicle, and the upper-limit speed, the one or more speed change plans each defining a speed change of the vehicle from the current position of the vehicle to the particular point, the one or more speed change plans each being configured to allow the vehicle to pass the particular point at a speed lower than the upper-limit speed; and
execute a visualization control process of visualizing the virtual object when the speed of the vehicle is determined as being higher than a speed defined by the one or more speed change plans, the visualization control process being configured to allow a driver who drives the vehicle to recognize a risk of the contact between the vehicle and the virtual object.

6. A non-transitory computer readable recording medium containing a computer program to be applied to a driving assistance apparatus, the driving assistance apparatus being configured to assist driving of a vehicle, the computer program causing, when executed by a computer, the computer to implement a method, the method comprising:
setting a position and a movement speed of a virtual object that is possibly to come out from a blind spot region present in a traveling direction of the vehicle;
executing a particular point identification process of identifying, as a particular point, a point at which the traveling direction of the vehicle and a moving direction of the virtual object intersect;
executing an upper-limit speed setting process of setting, as an upper-limit speed, a speed that a speed of the vehicle reaches by deceleration and that is of an upper limit to allow for avoidance of contact between the vehicle and the virtual object at the particular point;
executing a speed change plan setting process of setting one or more speed change plans based on a current position of the vehicle, a distance from the current position of the vehicle to the particular point, a current speed of the vehicle, and the upper-limit speed, the one or more speed change plans each defining a speed change of the vehicle from the current position of the vehicle to the particular point, the one or more speed change plans each being configured to allow the vehicle to pass the particular point at a speed lower than the upper-limit speed; and
executing a visualization control process of visualizing the virtual object when the speed of the vehicle is determined as being higher than a speed defined by the one or more speed change plans, the visualization control process being configured to allow a driver of the vehicle to recognize a risk of the contact between the vehicle and the virtual object.

7. A driving assistance method of assisting driving of a vehicle by a driving assistance system configured to assist the driving of the vehicle, the driving assistance method comprising causing the driving assistance system to:
set a position and a movement speed of a virtual object that is possibly to come out from a blind spot region present in a traveling direction of the vehicle;
execute a particular point identification process of identifying, as a particular point, a point at which the traveling direction of the vehicle and a moving direction of the virtual object intersect;
execute an upper-limit speed setting process of setting, as an upper-limit speed, a speed that a speed of the vehicle reaches by deceleration and that is of an upper limit to allow for avoidance of contact between the vehicle and the virtual object at the particular point;
execute a speed change plan setting process of setting one or more speed change plans based on a current position of the vehicle, a distance from the current position of the vehicle to the particular point, a current speed of the vehicle, and the upper-limit speed, the one or more speed change plans each defining a speed change of the vehicle from the current position of the vehicle to the particular point, the one or more speed change plans each being configured to allow the vehicle to pass the particular point at a speed lower than the upper-limit speed; and
execute a visualization control process of visualizing the virtual object when the speed of the vehicle is determined as being higher than a speed defined by the one or more speed change plans, the visualization control process being configured to allow a driver who drives the vehicle to recognize a risk of the contact between the vehicle and the virtual object.
